(19) United States
(12) Patent Application Publication
(10) Pub. No.: US 2014/0184780 A1
(43) Pub. Date: Jul. 3, 2014

(54) APPARATUS AND CONTROL METHOD THEREFOR

(71) Applicant: CANON KABUSHIKI KAISHA, Tokyo (JP)

(72) Inventor: Naoto Abe, Machida-shi (JP)

(21) Appl. No.: 14/237,043

(22) PCT Filed: Sep. 25, 2012
(86) PCT No.: PCT/JP2012/006109

§ 371 Date: Feb. 4, 2014

(30) Foreign Application Priority Data
Sep. 29, 2011 (JP) 2011-215299
Jul. 6, 2012 (JP) 2012-152645

(51) Int. Cl. G02B 21/36

(52) U.S. Cl. CPC G02B 21/361
USPC 348/80

(57) ABSTRACT

An imaging apparatus controls a size of an imaging region according to a spread of Z positions of substances in an object. For example, the imaging region becomes wide when the spread is small and becomes narrow when the spread is large. Or, the number of image sensors to be used is increased when the spread is small and is decreased when the spread is large. Or, an image sensor having a wide image pickup area is used when the spread is small, and an image sensor having a narrow image pickup area is used when the spread is large.

### TECHNICAL FIELD

The present invention relates to an imaging apparatus that images an object and generates a digital image.

### BACKGROUND ART

An imaging apparatus that picks up images of a segmented object and generates a combined image of the entire object by merging together a plurality of the obtained partial images is known. For example, Patent Literature (PTL) 1 discloses an image reading device of a system such that the central portion of an image pickup range is focused on an object and the object images are successively picked up, while changing the camera angle. The problem associated with such a system is that when the optical axis of the camera is tilted with respect to the planar object, the end portions of the image pickup range are out of focus and the image is blurred. Accordingly, the image reading device described in PTL 1 uses the configuration in which the difference in distance from the camera at both ends of the image pickup range to the object plane is determined for each camera angle and the image pickup range is divided so that half of this difference is less than the focal depth. Further, PTL 2 discloses a digital microscope in which a wide-range microscope image is generated by merging a plurality of images that are picked up separately.

### CITATION LIST

### Patent Literature

### [PTL 1]

Japanese Patent Application Publication No. 11-196315

### [PTL 2]

Japanese Patent Application Publication No. 2009-104161

### SUMMARY OF INVENTION

In an imaging apparatus that generates high-resolution and wide-range digital images, the time required to image the object and generate the digital image should be reduced. In particular, in an imaging apparatus that is used for diagnostics or analysis, as in the case of a digital microscope, the image processing of large-volume objects (slides or the like) is sometimes performed in a batch mode, and it is highly desirable that the processing time be reduced and the throughput be increased. Accordingly, in order to increase the speed of imaging and image generation, the inventor tried to reduce the number of imaging cycles (number of divisions) as much as possible by using a wide-field optical system and an image sensor having a wide image pickup (capture) area. By reducing the number of imaging cycles, it is possible to reduce not only the time required for the imaging operation, but also the time required for image processing, such as the formation of the combined image, and the increase in the total throughput can be expected. However, a problem arising when the field of view of the optical system and the image pickup area of the image sensor are enlarged is that image quality decreases (blurring of the image), as described hereinbelow.

The substances in the object are ideally arranged in one plane, but actually the positions of the substances in the optical axis direction (also described hereinbelow as Z axis direction) spread due to strains in the slide or cover glass. In the conventional imaging apparatus, the field of view is narrow and therefore the substances are practically not out of the depth of field within this narrow field of view even when a certain spread occurs in the positions of the substances in the optical axis direction. PTL 2 (paragraph [0007]) indicates that the variability in thickness of the slide causes no problem in a narrow field of view. Thus, with the conventional technique, an image of sufficient quality can be acquired even without paying any particular attention to the spread of the positions of the substances in the optical axis direction.

By contrast, in the imaging apparatus that has been researched and developed by the inventor, the field of view and image pickup area are wider than those in the conventional device. Accordingly, when a slide with a large spread of the positions of the substances in the optical axis direction is imaged, some of the substances are out of the depth of field and part of the image is blurred. This problem becomes more significant when an image sensor with a wide image pickup area is used to reduce the processing time and when the spread of the positions of the substances in the optical axis direction is large.

With the foregoing in view, it is an object of the present invention to provide a technique for suppressing the blurring of an image caused by the spread of the positions of the substances in the optical axis direction in the object and acquiring a high-quality image in an imaging apparatus having a wide field of view and a wide image pickup area.

The present invention in its first aspect provides an imaging apparatus that images an object and generates a digital image, comprising: an image sensor; an imaging optical system that enlarges and forms an image of the object on the image sensor; and an imaging control unit for controlling a size of an imaging region which is a range in which image data are acquired by the image sensor in one imaging cycle and controlling a focal position when the imaging region is imaged, wherein the object includes substances with different Z positions which are positions in the optical axis direction of the imaging optical system; and the imaging control unit determines the size of the imaging region according to a spread of the Z positions of the substances so that the imaging region in the case, where the spread of the Z positions of the substances is relatively large, is narrower than the imaging region in the case, where the spread of the Z positions of the substances is relatively small.

The present invention in its second aspect provides an imaging apparatus that images an object and generates a digital image, comprising: a plurality of image sensors; an imaging optical system that enlarges and forms an image of the object on the image sensors; and an imaging control unit, wherein the object includes substances with different Z positions which are positions in an optical axis direction of the imaging optical system; and the imaging control unit changes the number of image sensors to be used according to a spread of the Z positions of the substances so that the number of the image sensors to be used in the case where the spread of the Z positions of the substances is relatively large is less than the number of the image sensors to be used in the case where the spread of the Z positions of the substances is relatively small.

The present invention in its third aspect provides an imaging apparatus that images an object and generates a digital image, comprising: a plurality of image sensors with different image pickup areas; an imaging optical system that enlarges and forms an image of the object on the image sensors; and an imaging control unit, wherein the object includes substances with different Z positions which are positions in an optical axis direction of the imaging optical system; and the imaging control unit switches the image sensors to be used according to a spread of the Z positions of the substances so that the image pickup area of the image sensor to be used in the case where the spread of the Z positions of the substances is relatively large is narrower than the image pickup area of the image sensor used in the case where the spread of the Z positions of the substances is relatively small.

The present invention in its fourth aspect provides a method for controlling an imaging apparatus having an image sensor and an imaging optical system that enlarges and forms an image of an object on the image sensor, the method comprising: a determination step of determining a size of an imaging region which is a range in which image data are acquired by the image sensor in one imaging cycle and a focal position when the imaging region is imaged; and an imaging step of imaging the object with the size of the imaging region and at the focal position determined in the determination step and generating a digital image, wherein the object includes substances with different Z positions which are positions in an optical axis direction of the imaging optical system; and in the determination step, the size of the imaging region is determined according to a spread of the Z positions of the substances so that the imaging region in the case where the spread of the Z positions of the substances is relatively large is narrower than the imaging region in the case where the spread of the Z positions of the substances is relatively small.

The present invention in its fifth aspect provides a method for controlling an imaging apparatus having a plurality of image sensors and an imaging optical system that enlarges and forms an image of an object on the image sensors, the method comprising: a determination step of determining an image sensor to be used for imaging; and an imaging step of imaging the object by using the image sensor determined in the determination step and generating a digital image, wherein the object includes substances with different Z positions which are positions in an optical axis direction of the imaging optical system; and in the determination step, the number of image sensors to be used is changed according to a spread of the Z positions of the substances so that the number of the image sensors to be used in the case where the spread of the Z positions of the substances is relatively large is less than the number of the image sensors to be used in the case where the spread of the Z positions of the substances is relatively small.

The present invention in its sixth aspect provides a method for controlling an imaging apparatus having a plurality of image sensors with different image pickup areas and an imaging optical system that enlarges and forms an image of an object on the image sensors, the method comprising: a determination step of determining an image sensor to be used for imaging; and an imaging step of imaging the object by using the image sensor determined in the determination step and generating a digital image, wherein the object includes substances with different Z positions which are positions in an optical axis direction of the imaging optical system; and

in the determination step, the image sensors to be used are switched according to a spread of the Z positions of the substances so that the image pickup area of the image sensor to be used in the case where the spread of the Z positions of the substances is relatively large is narrower than the image pickup area of the image sensor to be used in the case where the spread of the Z positions of the substances is relatively small.

In accordance with the present invention it is possible to suppress the blurring of an image caused by the spread of the positions of the substances in the optical axis direction in the object and acquire a high-quality image in an imaging apparatus having a wide field of view and a wide image pickup area.

Further features of the present invention will become apparent from the following description of exemplary embodiments with reference to the attached drawings.

### BRIEF DESCRIPTION OF DRAWINGS

FIG. 1 illustrates an example of imaging regions and a depth of field in the imaging apparatus in accordance with the present invention.

FIGS. 2A and 2B illustrate schematically examples of imaging regions in the imaging apparatus in accordance with the present invention.

FIG. 3 is a block diagram illustrating the configuration of the imaging apparatus according to the embodiment of the present invention.

FIG. 4 is a flow chart illustrating the operation of the imaging apparatus of the first embodiment.

FIGS. 5A to 5C illustrate examples of an approximate curved surface of the Z positions of the substances and the focal position in each imaging region.

FIG. 6A illustrates an example of imaging regions of the conventional example, and FIGS. 6B and 6C illustrate examples of imaging regions of the first embodiment.

FIGS. 7A to 7C show examples of imaging region (main scanning width) of a line sensor.

FIG. 8 is a flowchart illustrating the operation of the imaging apparatus of the second embodiment.

FIGS. 9A and 9B illustrate examples of imaging regions of the second embodiment.

FIG. 10 is a flowchart illustrating the operation of the imaging apparatus of the third embodiment.

FIG. 11A illustrates an example of imaging regions of the conventional example, and FIGS. 11B to 11D illustrate examples of imaging regions of the fourth embodiment.

FIGS. 12A to 12D illustrate examples of imaging region of an area sensor.

FIG. 13 illustrates schematically the configuration of the imaging apparatus having a line sensor of the fifth embodiment.

FIGS. 14A and 14B show examples of imaging regions in the imaging apparatus shown in FIG. 13.

FIG. 15 shows schematically the configuration of the imaging apparatus having an area sensor of the fifth embodiment.

FIGS. 16A and 16B show schematically the configuration of an imaging unit having a plurality of area sensors.

FIGS. 17A and 17B show examples of imaging regions in the imaging apparatus shown in FIG. 15.

FIGS. 18A and 18B illustrate the imaging apparatus of the sixth embodiment.

FIGS. 19A and 19B illustrate the imaging apparatus of the sixth embodiment.

FIGS. 20A and 20B illustrate the imaging apparatus of the seventh embodiment.

FIG. 21 illustrates schematically the configuration of the imaging apparatus of the eighth embodiment.

FIGS. 22A and 22B are schematic cross-sectional views illustrating the structure of a slide.

FIGS. 23A and 23B illustrate schematically imaging regions in the case where an image sensor with a narrow image pickup area is used.

FIGS. 24A and 24B illustrate the Z positions of the substances and the depth of field in the case of a narrow image pickup area.

FIGS. 25A and 25B illustrate schematically imaging regions in the case where an image sensor with a wide image pickup area is used.

FIG. 26 illustrates the Z positions of the substances and the depth of field in the case of a wide image pickup area.

### DESCRIPTION OF EMBODIMENTS

The preferred embodiments of the imaging apparatus in accordance with the present invention are explained below with reference to the appended drawings. The present invention relates to a technique, in an imaging apparatus that images an object such as a slide and generates a digital image thereof, for suppressing the blurring of the image caused by the spread (variability) of the Z positions (positions in the optical axis direction) of the substances in the object and acquiring a high-quality digital image. The problem associated with the spread of the Z positions of the substances becomes more serious as the magnification ratio increases and the field of view gets wider. Therefore, the present invention can be more advantageously used in an imaging apparatus having a high-powered imaging optical system or an imaging apparatus that divides an imaging target region into a plurality of regions, picks up segmented images, and generates a wide-range total image by merging (combining) a plurality of obtained segmented images. For example, the imaging apparatus in accordance with the present invention can be advantageously applied to a digital microscope that is used in pathological diagnosis or sample analysis.

(Z Positions of Substances)

First, the Z positions of the substances are explained. In the system of coordinates of the imaging apparatus, a Z axis is taken to be parallel to the optical axis of the imaging optical system (objective lens), and an X axis and a Y axis are taken on a plane perpendicular to the optical axis. A stage parallel to the XY plane is provided between the imaging optical system (objective lens) of the imaging apparatus and an illumination system, and a slide is disposed as an object on the stage.

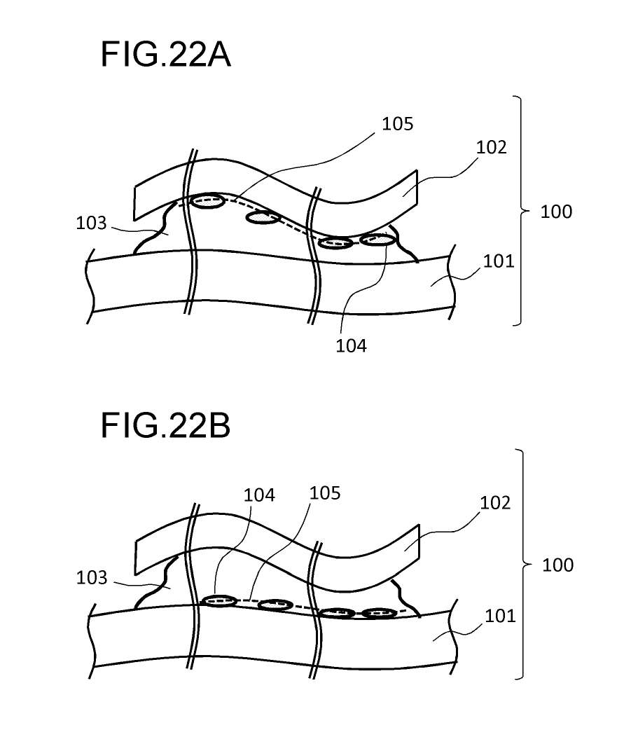

FIG. 22A and FIG. 22B are schematic cross-sectional views of the slide structure. In FIG. 22A and FIG. 22B, the upward direction is the direction toward the objective lens of the imaging apparatus and the downward direction is the direction toward the illumination system. The reference numeral 100 stands for a slide, 101 stands for a slide glass, 102 stands for a cover glass, 103 stands for a sealing agent, and 104 stands for substances. For example, natural resins and, in recent years, synthetic resins have been used for the sealing agent 103. The slide 100, which is an object, includes a plurality of substances 104. The substance 104 is, for example, a cell or a bacterium and can be dyed, as necessary, to facilitate the observations. Depending on the slide preparation method, the substances 104 may be concentrated close to the cover glass 102, as shown in FIG. 22A, concentrated close to the slide glass 101, as shown in FIG. 22B, or distributed in other locations. In the present description, the coordinate of the substance 104, which is wished to be observed (that is, photographed) by the observer, in the Z direction is referred to as the “Z position of the substance”. A dot line 105 shows a surface connecting the Z positions of a plurality of substances 104 present in the slide 100. As shown in FIG. 22A and FIG. 22B, the dot line 105 which represents the Z positions of the substances (also can be referred to hereinbelow simply as “Z positions 105 of the substances”) is often a curve of a shape that follows the peaks and valleys (waviness) of the surface of the cover glass 102 or the slide glass 101.

The spread of the Z positions 105 of the substances (also can be referred to hereinbelow simply as the “spread of the Z positions of the substances”) is related to the type of the slide glass 101, cover glass 102, and sealing agent 103 of the slide 100 or the preparation method (process) of the slide. An example of the Z positions 105 of the substances is shown in FIG. 22A and FIG. 22B, and the Z positions of the substances and the spread thereof can differ depending on the type of the substance and the slide preparation process.

In the embodiment of the present invention, a slide in which a plurality of substances (cells) used in cytodiagnosis is sealed with a resin is explained as an example of the object. However, the object considered in the present invention is not limited to a slide in which a plurality of such substances is at different Z positions. Thus, the present invention can be also advantageously applied to slides that are prepared by thinly slicing a tissue taken from a patient and sealing with a resin, a variety of such slides being used in tissue diagnosis. In this case, there may be one or a plurality of substances, depending on the type of the slice, but the “Z position of the substance” in the explanation below may be read as the “sample (sampling) position of the substance” and treated in the same way. Thus, the “Z positions of the substances” may be read as the “sample positions of the substance(s)”, and the “spread of the Z positions of the substances” may be read as the “spread of the sample positions of the substance(s)”. Further, a sample position with a sampling frequency higher than the frequency of variations in the Z positions of the substances may be selected to determine the advantageous sample position. In other words, the sample position may be determined with a pitch shorter than ½ of the variation of one period of the Z position of the substance.

(Depth of Field and Spread of the Z Positions of the Substances)

The depth of field and the spread of the Z positions of the substances are explained below. Similarly to other optical devices, there is also a relationship between the NA and the depth of field in the imaging apparatuses such as digital microscopes. Thus, the higher is the NA, the smaller is the depth of field.

In the conventional digital microscope, the view of field of the imaging optical system and the image pickup area of the image sensor are very small. Therefore, even when the NA is increased to obtain a sufficient resolution, the spread of the Z positions of the substances within such small image pickup area does not exceed the depth of field. For example, Patent Literature 2 (paragraph [0007]) clearly indicates that the spread in the thickness of the slide causes no problem in a narrow view of field. In other words, it can be said that in the conventional digital microscope, the slide 100 is prepared such as to accommodate all of the Z positions of the substances within the depth of field.

The imaging apparatus that has been researched and developed by the inventor has a function of performing a plurality of imaging operations, while changing the relative positions of the slide 100 and the image sensor and generating a high-resolution and wide-range combined image (entire image) by merging (combining) a plurality of obtained segmented images (partial images). In order to reduce the time required for the imaging operations and image combination processing, the inventor considered the possibility of reducing the number of imaging cycles by enlarging the image pickup area of the image sensor. However, as the region where an image is picked up is expanded, the difference between the maximum value and minimum value of the Z positions of the substances increases accordingly, and the possibility of some of the substances being out of the depth of field increases. Accordingly the spread of the Z positions of the substances that has not been a problem in the conventional imaging apparatus can cause blurring in part of the image.

For example, a method of decreasing the NA of the imaging optical system and increasing the depth of field can be considered to avoid such a problem. However, the problem arising when the NA is decreased is that the resolution decreases. Thus, a method of decreasing the NA is unsuitable from the standpoint of obtaining a high-resolution and wide-range combined image. Therefore, the inventor suggest a method for avoiding the blurring of the image caused by the spread of the Z positions of the substances, without decreasing the NA.

(Imaging Regions of Image Sensor and Spread of Z Positions)

The relationship between the imaging regions of the image sensor and the spread of the Z positions is described below in greater detail.

In the present invention, the range of the entire light-receiving surface of the image sensor is referred to as an “image pickup area”. Meanwhile, the “imaging region” is defined as a region of the entire image pickup area or part thereof in which image data are actually processed, that is, a range in which image data are acquired. As described hereinbelow, the imaging regions may be realized by image processing (a processing of selecting necessary image data from data of the image pickup area) or by changing the timing signal of the image sensor and restricting (cropping) a range of image data outputted by the image sensor.

As mentioned hereinabove, the imaging region is a range in which image data are acquired in one imaging cycle performed by the image sensor. For example, in the case of a one-dimensional image sensor, a rectangular range determined by the length of scanning (sub scanning) and the length of main scanning corresponding to the imaging region, and in the case of a two-dimensional image sensor, the range in which data are acquired by one shot of the image sensor corresponds to the imaging region. In the present description, the term “imaging region” is used to mean a region of the physical body surface on the object side (however, in some cases, a region on the image sensor side that corresponds to the imaging region on the object side is also referred to as the imaging region for the sake of convenience of explanation).

First, an imaging apparatus of a scan type (also called a scanner system) that uses a one-dimensional image sensor (line sensor) is explained. In such a system, a two-dimensional image is obtained by picking up images, while moving the slide 100 in the direction perpendicular to the line sensor.

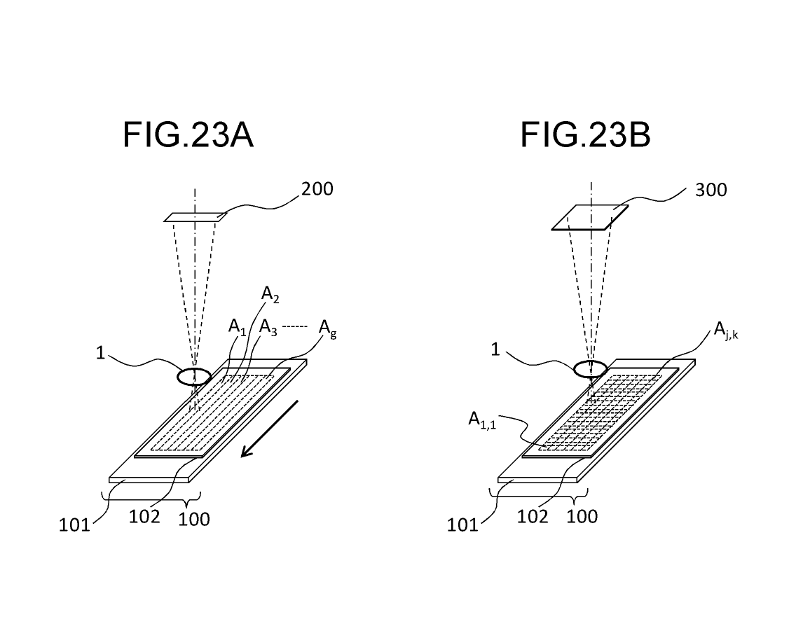

FIG. 23A shows schematically imaging regions (in this case, the range identical to the image pickup area) on the slide side of the imaging apparatus using the conventional line sensor. In FIG. 23A, the reference numeral 1 stands for a schematically shown imaging optical system, 100, 101, and 102 sand for the above-described slide, slide glass, and cover glass, respectively, and 200 stands for a line sensor which is an image sensor. The pixels of the line sensor 200 are arranged at a right angle to the direction shown by an arrow in FIG. 23A. Thus, a two-dimensional image is picked up by moving (sub scanning) the slide 100 in the direction shown by an arrow on a stage (not shown in the figure) with respect to the main scanning direction of the line sensor 200. For the sake of convenience, the main scanning direction will be referred to as a X direction and the sub scanning direction will be referred to as an Y direction.

In FIG. 23A, A₁ to A_{g} show schematically the imaging regions on the slide side that are picked up in one cycle of sub scanning. In this example, a wide-range combined image is generated by combining the images of g imaging regions that have been picked up in g scanning cycles.

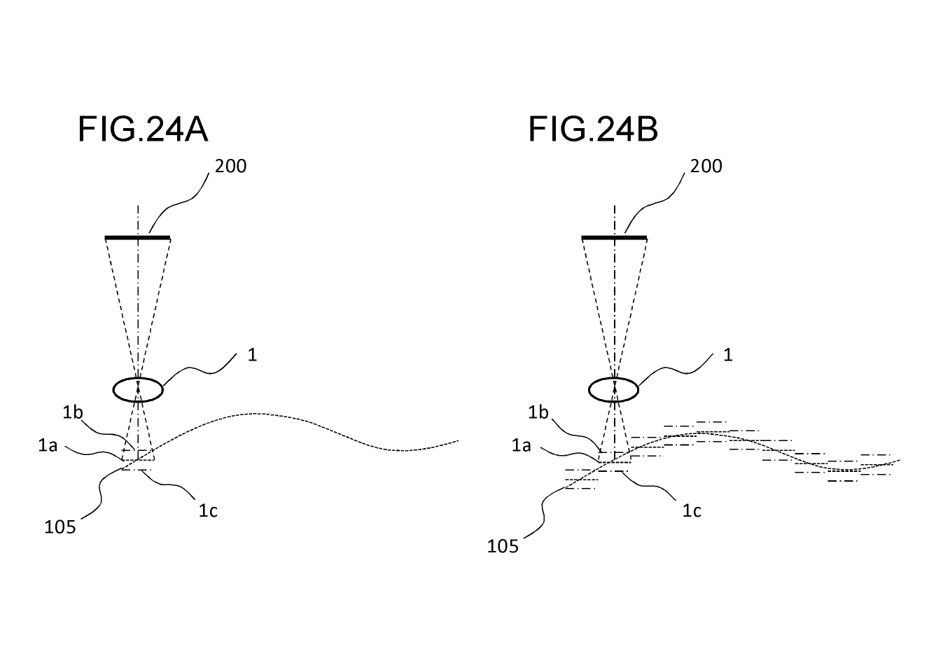

As mentioned hereinabove, in the conventional imaging apparatus, the imaging regions (line sensor length) of the image sensor are small and therefore the Z positions of the substances in the imaging regions A₁ to A_{g} of each scan are not out of the depth of field. FIG. 24A and FIG. 24B show schematically the Z position 105 of the substance in the imaging region on the slide side in each scan and the depth of field. In FIG. 24A and FIG. 24B, the reference symbol 1a stands for a focal position of the imaging optical system 1, 1b stands for a front focal position, and 1c stands for a rear focal position. The depth of field is the distance between the front focal position 1b and the rear focal position 1c. FIG. 24A and FIG. 24B are cross sectional views perpendicular to the sub scanning direction (Y direction), and the main scanning direction (X direction) is a left-right direction in the figures. FIG. 24A shows schematically the cross section of the imaging region of the first scan. As shown in FIG. 24A, the Z position 105 of the substance is clearly within the depth of field. FIG. 24B shows the cross section of the imaging region of the second scan. Likewise, the Z position 105 of the substance is also within the depth of field in the second scan. FIG. 24B also shows the focal position 1a, front focal position 1b, and rear focal position 1c in the first, second and subsequent scans.

An imaging apparatus using a two-dimensional image sensor (area sensor) is described below. This system is typically called an imaging apparatus of a digital camera type. In the imaging apparatus using an area sensor, a plurality of two-dimensional images is acquired by repeating (step and repeat) the processing of changing the relative positions of the slide 100 and the area sensor once the image of a certain imaging region (in this case, the range identical to the image pickup area) on the slide 100 has been picked up and then picking up the image of the next imaging region. A wide-range combined image is generated by combining (merging) those images.

FIG. 23B shows schematically the imaging regions on the slide side of the imaging apparatus using the conventional area sensor. In FIG. 23B, the explanation of the numerals explained with reference to FIG. 23A is omitted. In FIG. 23B, the reference numeral 300 stands for an area sensor. In FIG. 23B, A_{1,1}, to A_{j,k} show schematically the imaging regions on the slide side that are picked up by the area sensor 300 in one shot. In this example, a wide-range image of the entire imaging target region is generated by combining j×k images picked up in j×k step and repeat operations.

As mentioned hereinabove, in the conventional imaging apparatus, the imaging region (light-receiving surface area of the area sensor) of the image sensor is narrow. Therefore, the Z positions of the substances in the imaging regions A_{1,1}, to A_{j,k} of each shot are not out of the depth of field.

(Detailed Explanation of Problems Arising when Image Sensor with a Wide Image Pickup Area is Used)

Problems arising when the imaging regions of the image sensor are increased in size, that is, when an image sensor with a wide image pickup area is used, are explained with reference to the appended drawings.

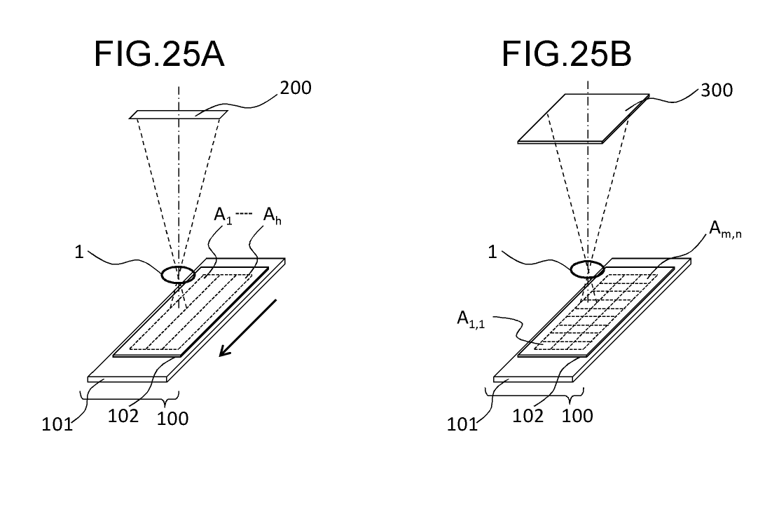

FIG. 25A and FIG. 25B illustrate schematically the imaging regions on the slide side in the imaging apparatus with enlarged imaging regions. In FIG. 25A and FIG. 25B, the reference numerals are same as those explained with reference to FIG. 23A and FIG. 23B and the explanation thereof is herein omitted.

FIG. 25A illustrates schematically the case in which the imaging region is increased in size by using a long line sensor 200. The image pickup time and the time required to generate a combined image are reduced by comparison with those in the imaging apparatus shown in FIG. 23A, since the number of scans is decreased from g to h.

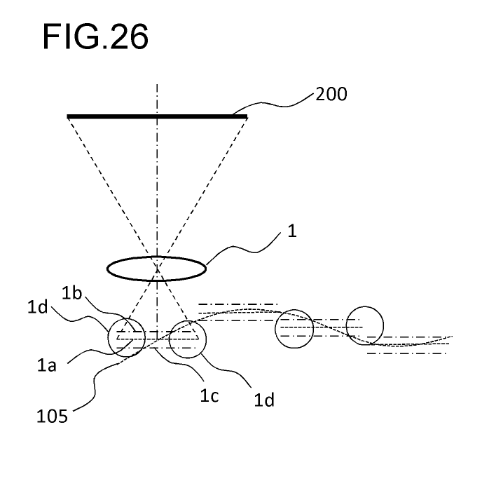

FIG. 26 shows schematically the Z positions 105 of the substances in the imaging region on the slide side in each scan and the depth of field in the case where the imaging region has been widened. In FIG. 26, the explanation of the reference numerals explained with reference to FIG. 24A is omitted. Comparing with FIG. 24A and FIG. 24B, it is clear that the imaging regions are enlarged and therefore, although the spread of the Z positions 105 of the substances is the same as in the conventional configuration, some of the substances (portion shown in the circle 1d) are out of the depth of field.

FIG. 25B is a schematic diagram relating to the case where the imaging regions are enlarged by using an area sensor 300 of a large light-receiving area. Comparing with the imaging apparatus shown in FIG. 23B, the number of shots is decreased from j×k to m×n, thereby making it possible to reduce the time required to generate the combined image. However, in this case, some of the substances can also be out of the depth of field for the same reason as explained with reference to FIG. 26.

As mentioned hereinabove, where the view of field of the imaging optical system 1 is increased, an image sensor with a wide image pickup area is used, and images are picked up in wider imaging regions in order to accelerate the process, some of the substances present in the imaging region are out of the depth of field because of the spread of the Z positions of the substances. A series problem that arises in such a case is that the picked-up image is blurred. It goes without saying that such a problem does not arise where the flatness of the slide is high and the spread of the Z positions of the substances is sufficiently small, but the process of preparing slides with a high flatness is time consuming and costly.

(Essential Points of the Invention)

Prior to explaining the embodiment of the present invention, the essential points of the present invention will be described in a simple manner.

The essential point of the present invention is that the spread (measured values or theoretic values (statistical data)) of the Z positions of the substances is acquired in advance and the imaging regions of the image sensor are adaptively determined according to the degree of this spread. More specifically, when the spread of the Z positions of the substances is large, the imaging region of the image sensor is narrowed, and when the spread of the Z positions of the substances is small, the imaging region is enlarged. Alternatively, it can be said that the imaging region is determined such that the image pickup in the case in which the spread of the Z positions of the substances has a second value that is larger than a first value is narrower than the imaging region in the case in which the spread of the Z positions of the substances has the first value. As a result, the imaging region can be determined such that the Z positions of the substances are confined within the depth of field and the blurred image can be prevented from being picked up.

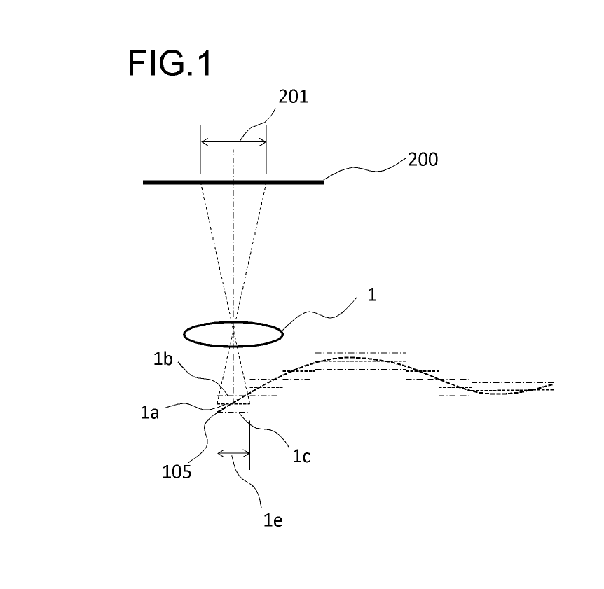

A method for determining the imaging region is described below in greater detail with reference to FIG. 1. FIG. 1 illustrates an example of the imaging region determined by the method in accordance with the present invention and the depth of field. In FIG. 1, the reference numeral 201 stands for an imaging region of the line sensor 200 that is narrowed according to the spread of the Z positions of the substances. The reference numeral 1e stands for an imaging region on the slide side that corresponds to the imaging region 201 of the line sensor 200.

By narrowing the imaging region 1e according to the spread of the Z positions 105 of the substances as shown in FIG. 1, it is possible to prevent the substances from getting out of the depth of field as shown by the reference numerals 1c and 1d in FIG. 26 and to prevent the image from being blurred. FIG. 1 shows the imaging apparatus using a line sensor as an image sensor, but it goes without saying that the present invention can be similarly applied to the imaging apparatus using an area sensor as the image sensor. In the case of an area sensor, two-dimensional spread of the Z positions of the substances may be considered.

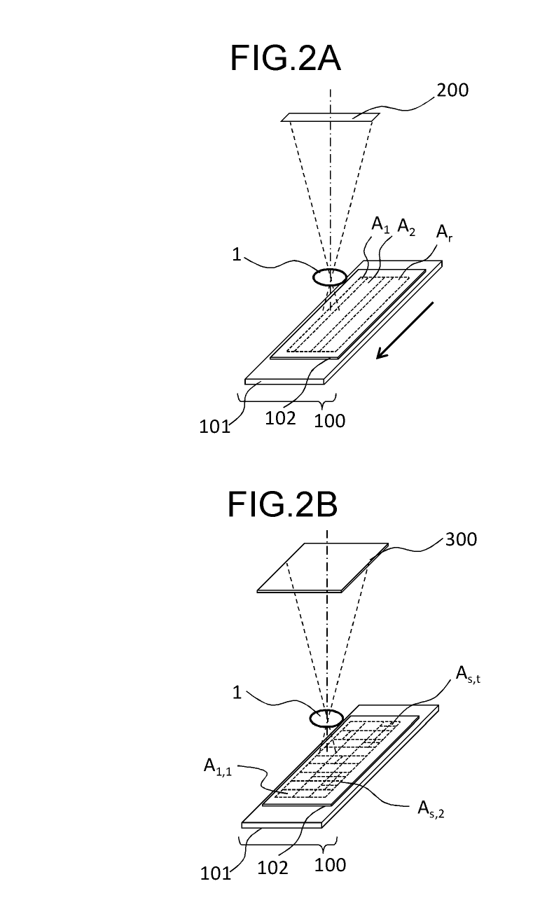

An example of the imaging regions determined by the abovementioned method is shown in FIG. 2A and FIG. 2B.

FIG. 2A shows schematically an example of the imaging regions on the slide side in the case where the method for controlling the imaging regions in accordance with the present invention is applied to the imaging apparatus using a line sensor. For example, with respect to the scan (for example, A₂, Aᵣ) in a portion with a small spread of the Z positions, the main scanning width is expanded to enlarge the imaging regions. With respect to the scan (for example, A₁) in a portion with a large spread of the Z positions, the main scanning width is shrunk to narrow the imaging regions.

FIG. 2B shows schematically an example of the imaging regions on the slide side in the case where the method for controlling the imaging regions in accordance with the present invention is applied to the imaging apparatus using an area sensor. In the shot (for example, A_{1,1}) in a portion with a small spread of the Z positions, the imaging regions are enlarged. In the shot (for example, A_{s,2}) in a portion with a large spread of the Z positions, the imaging regions are narrowed. In the example shown in FIG. 2B, the surface area of the imaging region in the portion in which the spread of the Z positions is large is narrowed to ¼.

By changing adaptively the size of the imaging regions as mentioned hereinabove, it is possible to prevent the occurrence of blurring in the image in a portion with a large spread of the Z positions of the substances. Further, since the imaging regions are enlarged in a portion with a small spread of the Z positions of the substances, the number of imaging cycles can be minimized and the total processing time can be reduced.

### First Embodiment

In the first embodiment of the present invention an example is explained in which the present invention is applied to an imaging apparatus using a line sensor as an image sensor. In the configuration of the entire system, one line sensor is disposed with respect to one imaging optical system 1, as shown in FIG. 2A.

(Configuration of Imaging Apparatus)

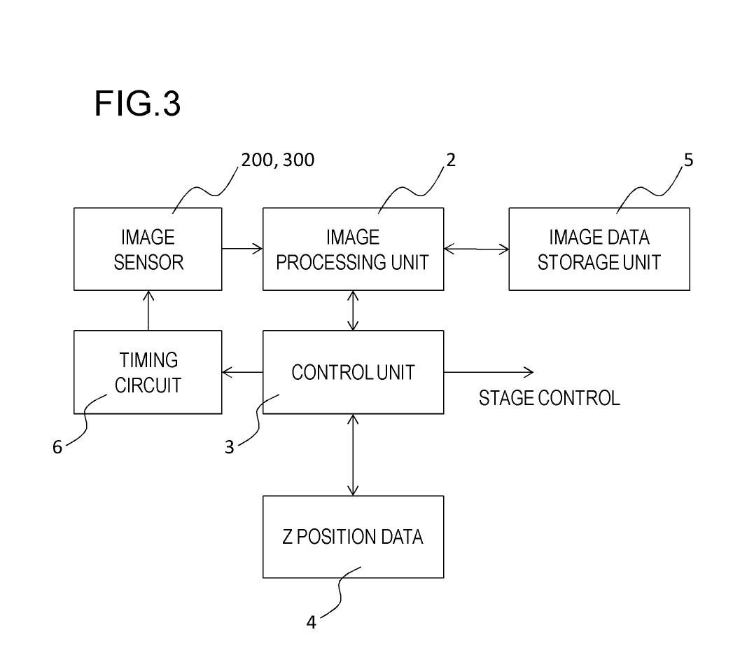

FIG. 3 is a block diagram illustrating the imaging apparatus of the first embodiment of the present invention. The imaging apparatus has a line sensor 200, which is an image sensor, an image processing unit 2, a controller unit 3, a memory 4 that stores data on the Z positions of the substances, an image data storage unit 5 that stores the created image data, and a timing circuit 6 that generates the operation timing of the line sensor 200. The imaging apparatus also has a stage that supports the slide, an illumination system that illuminates the slide, an imaging optical system that enlarges the optical image of the substance on the slide, and forms an image on the image plane of the line sensor 200, and a movement mechanism that moves the stage, but those components are not shown in the figure.

Referring to FIG. 3, the timing circuit 6 supplies timing signals to the line sensor 200. The line sensor 200 performs image pickup according to the timing at which the main scanning is performed and outputs image data. The outputted image data are processed by the image processing unit 2 under the control by the controller unit 3. The controller unit 3 and the image processing unit 2 may be realized in a simple manner by a microcomputer such as microcontroller chip. The image data processed by the image processing unit 2 are stored in the image data storage unit 5. The image data storage unit 5 is desirably a nonvolatile device such as a hard disk device. The image data stored in the image data storage unit 5 can be referred to, as appropriate, by a personal computer or the like connected by a network (not shown in the figure) or the like.

(Operation of the Imaging Apparatus)

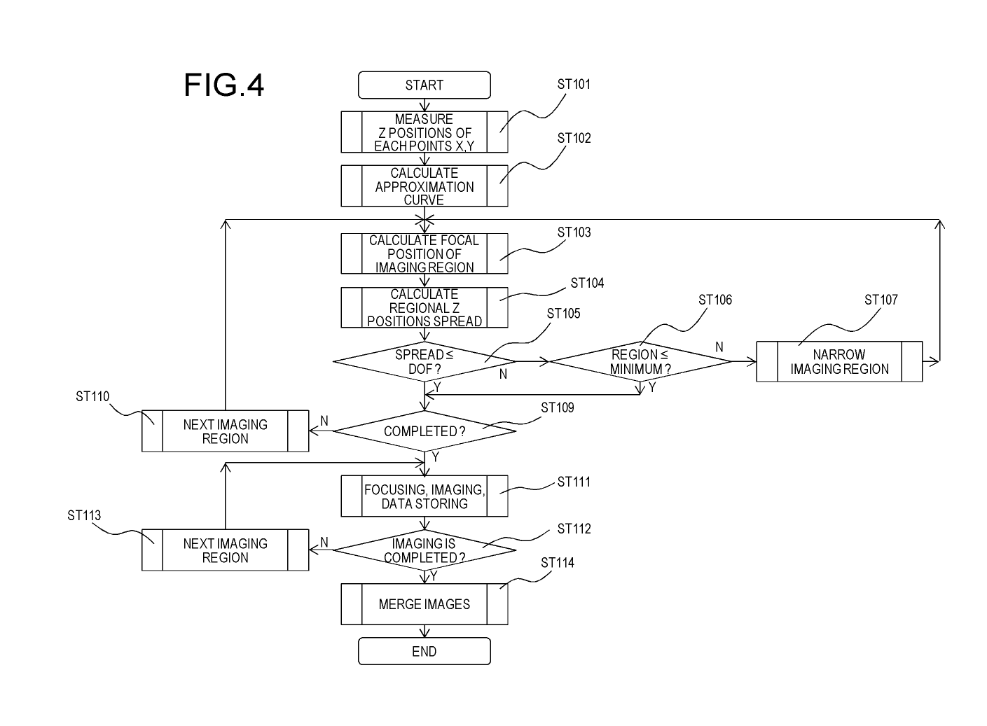

Specific operation of the controller unit 3 and the image processing unit 2 is illustrated by FIG. 4. FIG. 4 is a flowchart illustrating the processing executed by the controller unit 3 and the processing executed by the image processing unit 2 in response to the control command from the controller unit 3. As described hereinbelow, the controller unit 3 and the image processing unit 2 also function as an imaging control unit for adaptively controlling the image pickup conditions (size of the imaging region, focal position) according to the spread of the Z positions of the substances.

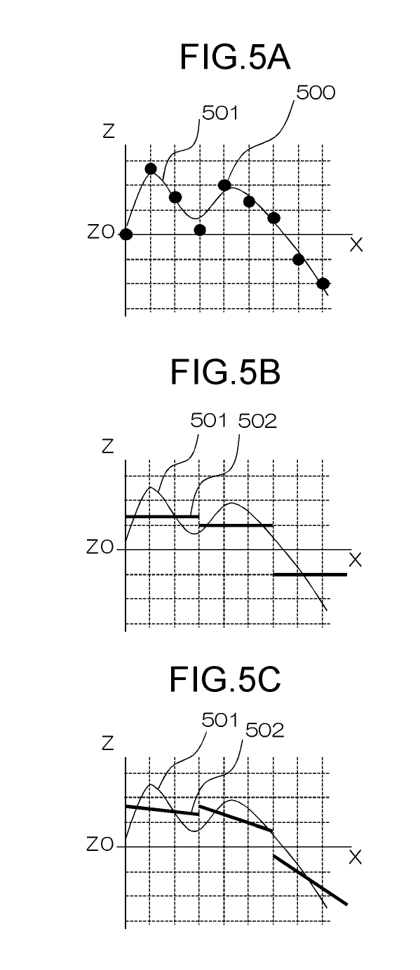

The succession of operation steps is explained below with reference to FIG. 4. First, in step ST101, the Z positions 105 of the substances on the slide are measured. A dedicated optical system or the imaging optical system 1 may be used for such measurements. A specific configuration of the measurement system is described below. In this step ST101, the Z positions corresponding to the X, Y coordinates of the substances can be measured. The measured Z positions of the substances are stored in the memory 4 in this step ST101. Then, in step ST102, an approximate curved surface is determined with respect to the measured Z positions of the substances, for example, by the least square method (it goes without saying that other methods may be also used). FIG. 5A shows schematically the approximate curved surface determined by the least square method with respect to the Z positions of the substances. In FIG. 5A the abscissa corresponds, for example, to the Z axis (it goes without saying, that it may correspond to the Y axis), and the ordinate represents the Z positions of the substances. The reference numeral 500 denotes the measured Z positions of the substances, and 501 denotes the approximate curved surface determined by the least square method or the like.

In step ST103, the focal position of the imaging region of each scan is calculated. FIG. 5B and FIG. 5C illustrate an example of the approximate curved surface of the Z positions of the substances and the focal positions of the imaging regions. In FIG. 5B and FIG. 5C, the abscissas and ordinates are same as those in FIG. 5A, and the reference numeral 502 stands for the focal positions connecting the focal points to the line sensor 200. FIG. 5B illustrates an example in which the Z coordinates of the focal positions 502 of each scan are calculated such as to minimize the difference between the focal position 502 of the line sensor 200 and the approximate curved surface 501 within the imaging region. In a simpler configuration, the Z coordinate of the center of the approximate curved surface 501 within the imaging region may be selected as the focal position 502. FIG. 5C illustrates an example in which the tilt (inclination) of the focal position 502 is controlled. In this case, the Z coordinate and tilt angle of the focal position 502 for each scan are calculated such as to minimize the difference between the focal position 502 and the approximate curved surface 501 within the imaging region. For example, after the Z coordinate of the focal position 502 has been determined such as to minimize the difference with the approximate curved surface 501, the focal position 502 may be tilted within a predetermined range and a tilt angle at which the difference with the approximate curved surface 501 is further reduced may be determined. The comparison of the configurations shown in FIG. 5B and FIG. 5C indicates that where the tilt control is also performed, it is highly probable that the difference between the approximate curved surface 501 and the focal position 502 of the line sensor 200 will be further decreased.

Then, in step ST104, the spread of the Z positions of the substances within this imaging region (referred to as “regional Z-positions spread”) is calculated from the approximate curved surface 501 within the imaging region and the focal position 502 determined in step ST103. In this case, a peak-to-peak value (pp value) of the difference between the approximate curved surface 501 within the imaging region and the focal position 502, that is, the difference between the maximum value and minimum value of the approximate curved surface 501 within the imaging region, is calculated as the regional Z-positions spread. As described hereinbelow, the regional Z-positions spread may be also calculated by other methods. In the present embodiment, the regional Z-positions spread is calculated after the focal position 502 has been determined, but it is also preferred that the focal position 502 be determined so as to minimize the regional Z-positions spread.

In the next step ST105, it is determined whether the regional Z-positions spread is equal to or less than the depth of field of the imaging optical system 1. Where the regional Z-positions spread is larger than the depth of field, the processing advances to step ST106 and it is determined whether or not the size of the present imaging region is a lower limit value. Where the imaging region is wider than the lower limit value, the processing advances to step ST107, the imaging region is narrowed, and the processing returns to step ST103. By repeating the loop of steps ST103 to ST107 and gradually narrowing the imaging region, it is possible to determine the size of the imaging region such that the regional Z-positions spread is equal to or less than the depth of field. By narrowing the imaging region in step ST107 by fine adjustment, it is possible to set the imaging region to a more adequate size (that is, to as large a surface area as possible). A specific example of the method for determining the imaging regions is described below.

The processing of step ST106 restricts the operation of narrowing the imaging regions. Where it is made possible to narrow the imaging regions, without restrictions, in the case of the slide 100 with a large spread of the Z positions, each imaging region can be narrowed too much, the number of imaging regions (number of scans) becomes large, and the image pickup time is increased. Step ST106 is designed to prevent the occurrence of such a problem. However, when the number of scans and image pickup time are not a problem, this step may be omitted. Further, it is preferred that the lower limit value used in step ST106 could be changed by the user according to application. For example, when the image quality is a priority, it is possible to set a small lower limit value and minimize the number of substances out of the depth of field, and when the processing speed is more important, it is possible to set a large lower limit value so that the number of scans or the number of segmented images is not too large.

Where the regional Z-positions spread is determined in step ST105 to be equal to or less than the depth of field of the imaging optical system 1, the processing advances to the next step ST109. In step ST109, it is determined whether the calculation of the focal position and the size of the imaging regions of all of the scans (also referred to hereinbelow simply as scans) has been completed. Where the calculation has not been completed, the processing advances to step ST110, the coordinates are changed to the next scan, and the processing returns to step ST103. In this case, it is preferred that measures be taken to change timely the size of the imaging region of each scan so that no gaps appear in the imaging regions between the scans. However, even when gaps or overlapping portions are present, odd-looking images of the connection portions can be present, but for other portions, no odd-looking images are obtained. Therefore, for some applications, the presence of gaps or overlapping portions may be allowed. In this case, a boundary (black frame or the like) may be provided between the segmented images obtained in each scan, or the segmented images may be smoothly connected to each other by interpolation.

Where it is determined in step ST109 that all of the calculations have been completed, the processing advances to the next step ST111. In step ST111, the stage is moved and the focus is adjusted according to the focal position (Z coordinate, tilt angle) and the position (X, Y coordinates) of the imaging region (scan) determined in the aforementioned processing and the image is actually picked up in the size determined for each imaging region. More specifically, it is preferred that the image processing unit 2 input the image data of the image pickup area from the image sensor 200 and process the inputted data by using the data on the image region portions. The image data are then stored together with the coordinate information in the image data storage unit 5.

The adjustment of the focal position for each scan may be performed by adjusting the focus of the imaging optical system 1 or moving the line sensor 200, or by moving the stage supporting the slide or the stage supporting the line sensor 200. When the focal position is adjusted by moving the stage, the stage is translated in the Z direction so as to match the focal position 502 shown in FIG. 5B with the focal position of the imaging optical system 1. In the case of the method illustrated by FIG. 5C, the stage is translated in the Z direction and the stage is also tilted so that the inclination of the focal position 502 follows the approximate curved surface 501. A well known drive mechanism can be used for translating or tilting the stage.

In the next step ST112, it is determined whether the imaging operation has been completed with respect to all of the scans. Where the imaging operation has not been completed, the processing advances to step ST113, the stage is moved to the next scan, and the processing returns to step ST111 to perform the image pickup. Where the image pickup of all of the scans has been completed in step ST114, the image processing unit 2 reads all of the segmented images that have been scanned and stored in the image data storage unit 5, creates a combined image, and stores the combined image in the image data storage unit 5. In this case, images of wide regions are picked up in each scan so that the images of the adjacent imaging regions partially overlap, and the images are preferably combined by trimming each image or alpha-blending the images together so as to prevent the appearance of gaps between the imaging regions.

(Method for Determining Imaging Regions)

A method for determining the imaging regions in steps ST103 to ST107 is explained below in greater detail.

As mentioned hereinabove, the width of the main scanning (the region of pixels used for image pickup) in a line sensor can be changed by the image processing unit 2. Therefore, where the width of the main scanning and focal position are adjusted in each main scan, the spread of the Z positions of the substances can be reliably confined within the field region (the imaging region in this case is a linear region). However, in this case, when the region can be changed for each main scan, the number of scans (number of imaging regions) greatly increases and the processing time increases. Therefore, a realistic approach is to form a rectangular imaging region by performing a certain sub scanning, while maintaining the same width of the main scanning.

In the first method, the sub scanning of the entire range is performed without changing the width of the main scanning for each main scanning, but the width of the main scanning is changed for each sub scanning (for each imaging region). In other words, in the first method, only the width of the main scanning is controlled for each imaging region. The width of the main scanning in each sub scanning (each imaging region) can be determined by estimating whether the regional Z-positions spread is equal to or less than the depth of field, while gradually decreasing the width of the main scanning from the maximum value in the loop of steps ST103 to ST107 shown in FIG. 4.

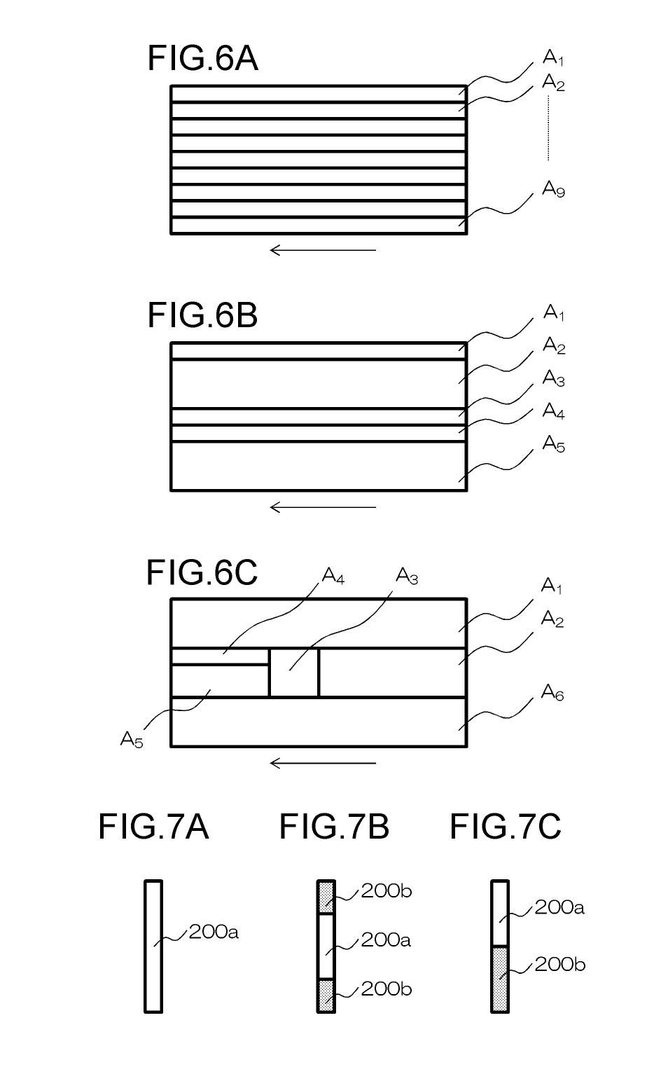

FIG. 6A shows an example of the imaging regions obtained by the conventional method, and FIG. 6B shows an example of the imaging regions obtained by the first method. In FIG. 6A and FIG. 6B, A₁ to A₉ show the scan numbers. In the conventional method, all of the imaging regions have the same size. By contrast, in the first method the width of the main scanning is adaptively changed for each sub scanning. In other words, in a portion with a large spread of the Z position, the imaging regions are determined such that the width of the main scanning decreases in the order of A₁, A₃, A₄, and in a portion with a small spread of the Z positions, the width of the main scanning is increased in the order of A₂, A₆. Therefore, the number of scans decreases by comparison with that in the conventional method shown in FIG. 6A, and both the suppression of blurring of the image (increase in image quality) and reduction of the processing time can be expected. With such first method, the boundaries of images (merging portions) are only the sides parallel to the sub scanning direction. The resultant merit is that the combination processing is simplified by comparison with that of the below-described second method. Further, since it is not necessary to perform focus adjustment in the course of sub scanning, the image pickup processing can be performed efficiently.

With the second method, both the width of the main scanning and the width of the sub scanning are controlled. In this case, the width is reduced in two directions and therefore the loop of steps ST103 to ST107 should be somewhat deformed. For example, the width of the main scanning and the width of the sub scanning are changed and whether or not the regional Z-positions spread is equal to or less than the depth of field is estimated for all of the rectangular regions that are to be acquired. Then, among the rectangular regions for which the regional Z-positions spread is equal to or less than the depth of field, the region with the largest surface area may be selected as the imaging region. Alternatively, a candidate rectangle relating to the case in which the width of the main scanning is fixed at the maximum value and only the width of the sub scanning is reduced and a candidate rectangle relating to the case in which the width of the sub scanning is fixed at the maximum value and only the width of the main scanning is reduced may be calculated and the rectangle with a larger surface area from those two candidate rectangles may be selected as the imaging region. The advantage of the latter method is that the search for the candidates can be simplified and the computational processing time can be reduced.

FIG. 6C shows an example of the imaging regions determined in the second method. In a portion in which the spread of the Z positions is large, the imaging regions are determined such that the width of the main scanning, or sub scanning, or both the main scanning and the sub scanning decreases in the order of A₂ to A₅, and in a portion with a small spread of the Z position, the width of the main scanning and sub scanning increases in the order of A₁, A₆. Therefore, the number of scans decreases by comparison with that in the conventional method illustrated by FIG. 6A, and both the suppression of blurring of the image (increase in image quality) and reduction of the processing time can be expected. With the second method, the Z position and Z tilt of the stage can be adjusted in the units of rectangular imaging regions that are determined by the width of the main scanning and the width of the sub scanning.

With the third method only the width of the sub scanning is controlled. The width of the sub scanning can be determined by estimating whether or not the regional Z-positions spread is equal to or less than the depth of field, while gradually decreasing the width of the sub scanning from the maximum value, in the loop of steps ST103 to ST107 shown in FIG. 4. The width of the main scanning may be fixed, for example, at a maximum value.

The above-described first to third methods are presented by way of example, and the adequate method may be selected according to the trend in the spread of the Z positions of the substances in the slide to be imaged. For example, when the Z position changes along the main scanning direction, the first method may be selected, when the Z position changes along the sub scanning direction, the third method may be selected, and when the Z position changes two dimensionally, the second method may be selected. When a high-quality image is wished to be obtained by reliably confining the substances within the depth of field, a method for adjusting the focal position for each main scanning may be used. It goes without saying that in this case the calculation of the spread of the Z position is performed after the focal position has been adjusted for each main scanning.

FIGS. 7A, 7B, and 7C illustrate the relationship between the width of the main scanning and the imaging region of the line sensor 200. In each figure, the vertical direction is the main scanning direction. The reference numeral 200a stands for an imaging region (range of pixels for which image data are acquired), and the reference numeral 200b stands for an image non-pickup region (range of pixels for which image data are not acquired). FIG. 7A shows the imaging region 200a (that is, the image pickup area) of the line sensor 200 in the case in which the imaging region is not restricted (the case in which the width of the main scanning is at a maximum). In other words, an image is received from all of the effective pixels of the line sensor 200. FIG. 7B and FIG. 7C both show the imaging region 200a of the line sensor 200 in the case in which half of the width of the main scanning is restricted. FIG. 7B illustrates a method of using the pixels of the central portion of the line sensor 200, and FIG. 7C illustrates a method of using the pixels of the upper portion (one end portion) of the line sensor 200. Any method may be used, but in the present embodiment, the method illustrated by FIG. 7B is used. Optical characteristics of the imaging optical system 1 are typically better in the central portion than in the peripheral portion. This is why an image of higher quality can be acquired by using the pixels positioned in the central portion of the field of view of the imaging optical system 1, from among the effective pixels of the line sensor 200.

When the size of the imaging regions is determined, it is desirable that the size of the imaging regions be determined such that the maximum value is obtained when the regional Z-positions spread is within a range of equal to or less than the depth of field. This is because in such a case, the number of imaging cycles can be minimized and both the time required for the image pickup processing and the time required to generate the combined image can be reduced.

(Measurement of Z Positions of Substances)

The measurement of the Z positions 105 of the substances in step ST101 will be described below in greater detail. The methods for measuring the Z positions 105 of the substances on the slide can be generally classified into methods by which the Z positions of the substances is estimated by using an image and methods by which surface peaks and valleys of the cover glass or slide glass are measured by using distance sensors using the reflected light or interference light. In the former methods, an autofocus technique can be used in the camera. For example, an image can be obtained with the line sensor 200, while changing the focus position on the slide side, and the focus position at which the differential value of the image signal is at a maximum can be taken as the Z position of the substance. The latter methods include an optical distance measurement method using a triangular measurement method such as disclosed in Japanese Patent Application Publication No. H6-011341 and a method for measuring the difference between the distances traveled by the laser beam reflected by the boundary surface of the glass by using a confocal optical system such as disclosed in Japanese Patent Application Publication No. 2005-98833.

The Z positions of the substances may be measured with a measurement device separate from the imaging apparatus or by a measurement device integrated with the imaging apparatus. In the configuration integrated with the imaging apparatus, it is preferred that an optical system and a measurement system for measuring the Z positions be provided, and the imaging optical system 1 used for image pickup can be also used for measuring the Z positions. In this case, the imaging optical system 1 may be additionally provided with optical components for measuring the Z positions. As for the measurement system (sensor), a dedicated sensor may be used, or an image sensor (in the present embodiment, the line sensor 200) designed for image pickup can be also used.

(Regional Z-positions Spread)

In the above-describes step ST104, the regional Z-positions spread is determined by the pp value of the difference between the approximate curved surface 501 within the imaging region and the focal position 502 of the image sensor. With such a method, the approximate curved surface 501 of the Z positions of the substances is always confined within the depth of field. Therefore, practically all of the substances in the imaging regions are within the depth of field.

However, where the size of the imaging regions is determined only by the peak values (maximum value, minimum value) as in this method, the imaging regions can be unnecessarily narrowed even when not all of the substances are distributed at the Z positions close to the peak values. This trend is particularly significant where the measurement values of the Z positions include noise, or where local changes in the Z positions are very large. Undesirable consequences of the imaging regions being narrowed more than necessary include an increase in the number of scan cycles and extension of the processing time required for image pickup and formation of a combined image.

The research conducted by the inventor demonstrated that where the regional Z-positions spread is determined as described hereinabove, each imaging region can be expanded (that is, processing time can be reduced), while confining practically all of the Z positions of the substances within the depth of field. Thus, the regional Z-positions spread is determined on the basis of the standard deviation (Sigma) of the differences between the approximate curved surface 501 in the imaging region and the focal position 502 of the image sensor. For example, a six-fold standard deviation (two-fold Three Sigma value) may be determined as the regional Z-positions spread. Further, an about two-fold standard deviation (Sigma) may be determined as the regional Z-positions spread in order to reduce further the number of scans. From the standpoint of balance between speed and quality, it is preferred that a value within a range between the standard deviation and six-fold standard deviation be set as a coefficient. It is also preferred that the coefficient assigned to the standard deviation or the settings of the regional Z-positions spread could be selected by the user. For example, when it is wished that the combined image be generated within a short time, even with a certain degradation of image quality, a coefficient of one may be selected for the standard deviation, and when high quality is required, even if the process takes extra time, a six-fold standard deviation or pp value may be selected as the regional Z-positions spread.

In the present embodiment, the spread in the difference between the approximate curved surface 501 determined from the Z positions of a plurality of substances and the focal position 502 is taken as the “spread of the Z positions of the substances”. This is because such an approach has the following advantage. Thus, by using the approximate curved surface, it is possible to decrease the number of measurement points for the Z positions and remove the noise originating when the Z positions of the substances are measured. When the number of measurement points is sufficient or when the noise causes no problem, the spread in the difference between the Z positions of the substances (measurement values) themselves and the focal position 502 may be taken as the “spread of the Z positions of the substances”.

As mentioned hereinabove, in the first embodiment of the present invention, the present invention is applied to an imaging apparatus of a type in which a two-dimensional image of the substances 104 on the slide 100 is acquired by scanning with a one-dimensional image sensor (line sensor). In the present embodiment, the size of the imaging regions is adaptively determined according to the spread of the Z positions of the substances so that the imaging regions are narrower in the case where the spread of the Z positions of the substances is relatively large than in the case where the spread of the Z positions of the substances is small. With such a control, the substances in the imaging regions are less probable to be out of the depth of field even when the spread of the Z positions of the substances is large. In particular, in the present embodiment, the size of the imaging regions and the focal position (Z position, tilt) are determined such that the Z positions of the substances are confined within the depth of field. Therefore, the probability of the substances getting out of the depth of field can be minimized and an image that is focused better and has quality higher than that in the conventional configurations can be acquired. Further, in the present embodiment the regional Z-positions spread (pp value, standard deviation, and the like), which is the statistical amount of the spread of the Z positions of the substances in the imaging region, is calculated and it is estimated whether or not the regional Z-positions spread is equal to or less than the depth of field. By so using the statistical amount (representative values), it is possible to simplify the estimation algorithm and reduce the processing time.

### Second Embodiment

The second embodiment of the present invention is described below. In the above-described first embodiment, the regional Z-positions spread is calculated from the results obtained by performing actual measurements on the slide, whereas in the second embodiment, the regional Z-positions spread is determined from the statistical data acquired from a database.

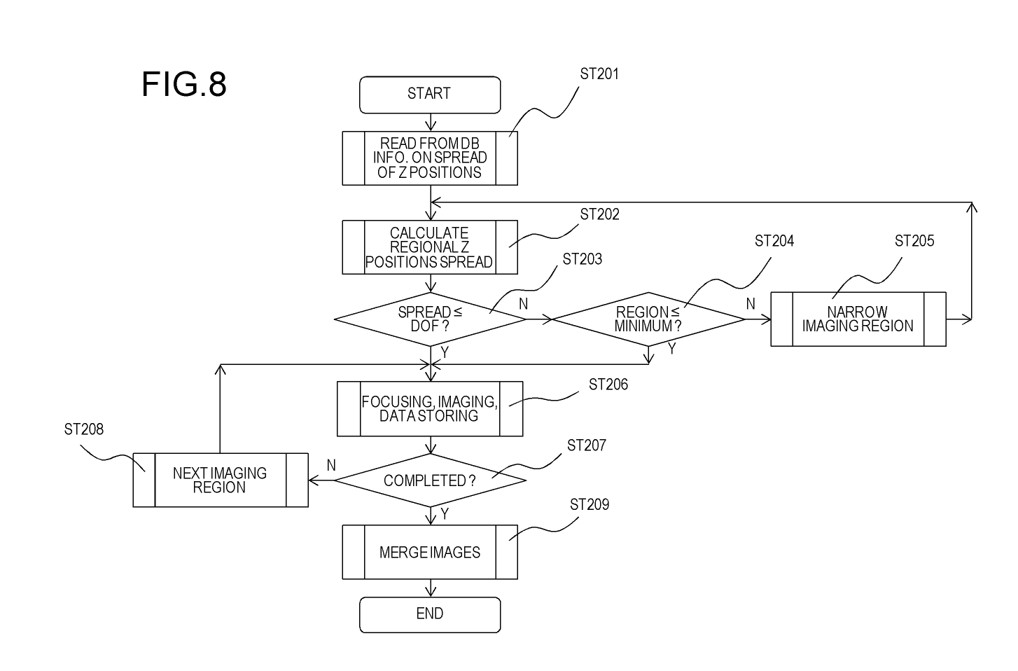

The configuration of the second embodiment is identical to that of the first embodiment, as shown in FIG. 3. The main difference between the second embodiment and the first embodiment is in the processing procedure. FIG. 8 illustrates a specific operation of the controller unit 3 and the image processing unit 2 of the second embodiment of the present invention. The operation steps shown in FIG. 8 are explained successively below.

First, in step ST201, information on the spread of the Z positions of the substances is read from the database. The database may be provided in the memory 4 of the imaging apparatus, or may be provided in another storage device on a network. The “information on the spread of the Z positions” as referred to herein is data indicating the statistical degree of the spread of the Z positions of the substances. For example, the information on the spread of the Z positions can be generated by performing the measurements on a large number of slides and finding the average spread of the Z positions thereof. As the information on the spread of the Z positions, a spread of the Z positions of the substances per unit region (unit surface area or unit length) (for example, the pp value or standard deviation (Sigma) of the difference between the approximation curve of the Z positions of the substances per unit region and the focal position) can be effectively used.

The spread of the Z positions of the substances typically differs depending on the preparation conditions such as the slide preparation process, type of the substances, person who prepares the slide, and type of the cover glass and slide glass. Accordingly, the information on the spread of the Z positions is prepared in the database for each set of conditions, and it is preferred that in step ST201 the controller unit 3 refer to the database on the basis of the abovementioned conditions and acquire the information on the spread of the Z positions that conforms to the slide for which the image pickup is to be performed. Those conditions may be added as object attribution information to the slide or a cartridge (accommodation body; not shown in the figure) that houses the slide. For example, an information tag having the object attribution information recorded therein may be affixed to the slide or the cartridge, and the controller unit 3 may read the necessary information from the information tag by using a reader (not shown in the figure). A printed tag such as a bar code or a two-dimensional code can be used as the information tag, and a tag on which the information is recorded electromagnetically, such as a memory chip or a magnetic tape, can be used.

In step ST202, the regional Z-positions spread of the present imaging region is calculated from the information on the spread of the Z positions obtained from the database. For example, when the pp value or standard deviation (Sigma) per unit area is obtained as the information on the spread of the Z positions, a value obtained by multiplying the pp value or standard deviation by the surface area of the present imaging region is taken as the regional Z-positions spread. In the case of standard deviation, the product may be further multiplied by a coefficient of 1 to 6. As described in the first embodiment, the value of the coefficient may be selected from a range of 1 to 6 according to the balance between the speed and the quality.

The above-described flow means that where the size (length or surface area) is determined, the regional Z-positions spread of the slide for which the image is actually picked up can be determined from the information on the spread of the Z positions, which is statistical data. By contrast with the first embodiment, in the second embodiment, the values of the regional Z-positions spread that differ according to the scan location are not outputted. Thus, all of the imaging regions on the slide have the same size.

The spread of the Z positions typically can be made less in the case where both the Z position and the Z tilt of the stage are adjusted than in the case where only the Z position is adjusted. Therefore, it is desirable that the information on the spread of the Z positions assume different values in the case where only the Z position is adjusted and the case where both the Z position and the Z tilt are adjusted. Accordingly, data of two types (information on the spread of the Z positions) are registered in the database and the data to be used are switched depending on whether or not the Z tilt is performed (or depending on whether or not the imaging apparatus can be tilt controlled). In the case where there are only data relating to the case in which only the Z position is adjusted, a value obtained by multiplying the regional Z-positions spread that is calculated from those data by a coefficient that is less than one may be taken as the regional Z-positions spread in the case in which both the Z position and the Z tilt are adjusted.

Then, in step ST203, it is determined whether the regional Z-positions spread calculated in step ST202 is equal to or less than the depth of field of the imaging optical system 1. Where the regional Z-positions spread is equal to or more than the depth of field, the processing advances to step ST204. In step ST204, a restriction processing is performed such as to prevent the size of the imaging regions from being too small (preventing the number of imaging regions from being too large) in the same manner as in step ST106 of the first embodiment. In step ST205, the size of the imaging regions is reduced. The processing of steps ST202 to ST205 is repeated till the regional Z-positions spread is equal to or less than the depth of field or till the size of the imaging regions becomes a lower limit value. Once the size of the imaging regions has been determined in the abovementioned processing, the image of each imaging region is picked up in step ST206. The processing of steps ST206 to ST209 is identical to that of steps ST111 to ST114 of the first embodiment.

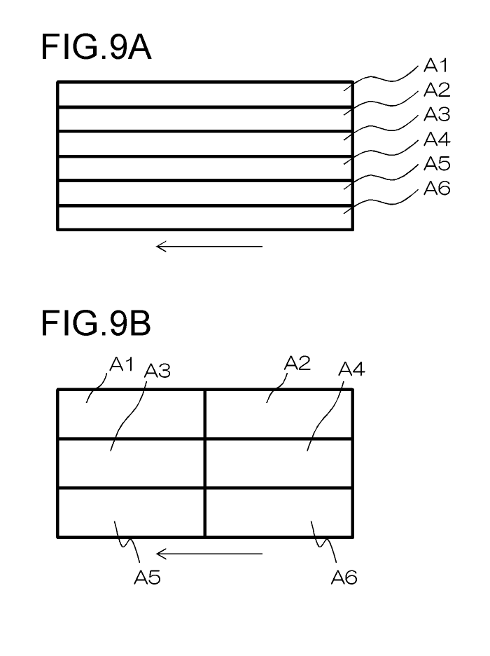

FIG. 9A and FIG. 9B illustrate the examples of imaging regions in the method of the second embodiment. FIG. 9A illustrates an example in which only the width of the main scanning is controlled, and FIG. 9B illustrates an example in which both the width of the main scanning and the width of the sub scanning are controlled. The difference between the method of the second embodiment and that of the first embodiment (FIG. 6B and FIG. 6C) is that all of the imaging regions have the same surface area in the method of the second embodiment. Comparing with the conventional method (FIG. 6A), in a slide with a small spread of the Z positions, the number of imaging regions can be decreased, and it is possible to suppress the blurring of the image (image quality can be increased) and also reduce the processing time.

Thus, in the second embodiment of the present invention, the size of the imaging regions is adaptively changed according to the spread of the Z positions of the substances and therefore the substances also can be prevented from getting out of the depth of field and the blurring of the image can be suppressed in the same manner as in the first embodiment. In the first embodiment, the size of each scan is determined according to the spread of the actual Z positions, but in the second embodiment, the size of each scan is determined from the statistical data of the spread of the Z position. The merit of the method according to the second embodiment is that the size of the imaging regions is the same and the stage control and combination algorithm are simple. Further, in the second embodiment, the processing time can be further reduced, since it is not necessary to measure the spread of the Z positions in the slide each time.

In the second embodiment, the information on the spread of the Z positions is acquired from the database, but it is also possible to measure the Z positions of the substances in the target slide in a plurality of points and calculate a statistical amount (for example, an average value) from the obtained measurement values, thereby obtaining the information on the spread of the Z positions. With such a method, the information on the spread of the Z positions is obtained from the slide for which the image pickup is actually performed. Therefore, the blurring of the image can be expected to be suppressed better (image quality can be increased more) than in the case of using general-use data acquired from the database. Yet another advantage over the method of the first embodiment is that the processing algorithm is facilitated.

### Third Embodiment

The third embodiment of the present invention is explained below. In the third embodiment of the present invention, the imaging regions are determined by an algorithm that is simpler than those used to determine the imaging regions from the regional Z-positions spread in the first and second embodiments.

The configuration of the imaging apparatus of the third embodiment which is shown in FIG. 3 is identical to that of the first and second embodiments. The main difference between the third embodiment and the first and second embodiments is in the processing procedure.

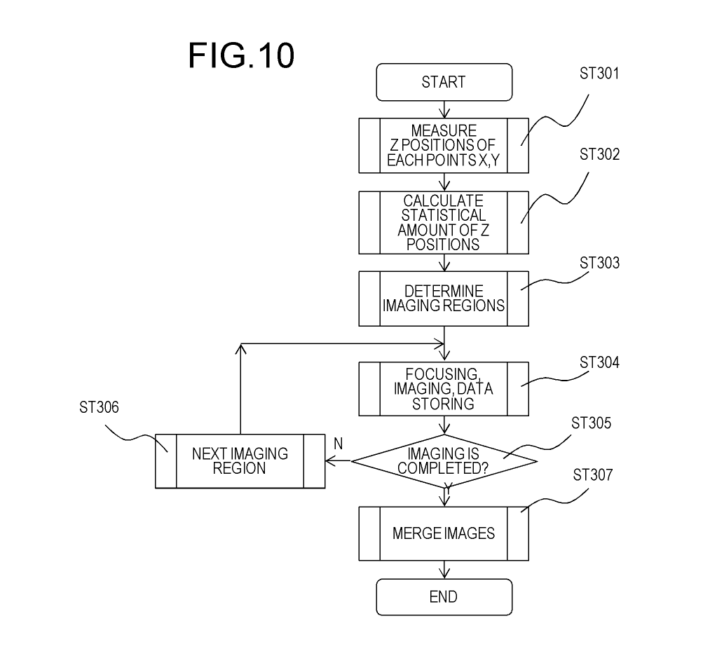

The processing flowchart of the third embodiment of the present invention is shown in FIG. 10.

Each operation step of the processing flow shown in FIG. 10 is explained below. First, in step ST301, the Z positions of the substances in the target slide are measured in the same manner as in step ST101 of the first embodiment. In this step ST301, the Z positions of the substances in the X, Y coordinates can be measured.

In the next step ST302, a statistical amount (for example, standard deviation (Sigma)) corresponding to the spread of the Z positions is determined from the measured Z positions of the substances and the approximate curved surface determined therefrom. In the present embodiment, the statistical amount is determined from the measurement values of the target slide, but the information on the spread of the Z positions of the substances may be also acquired from the database or the like, as described in the second embodiment.

Then, in step ST303, the imaging regions are directly determined from the statistical amount corresponding to the spread of the Z positions determined in step ST302. For example, in a simple approach, a reference table in which the statistical values are associated with the size of the imaging regions is prepared in advance and the imaging regions are determined by using the reference table.

It is desirable that the reference table include information of two types, namely, relating to the size of the imaging regions in the case in which only the Z position is adjusted and the size of the imaging regions relating to the case in which both the Z position and the Z tilt are adjusted. In the case in which both the Z position and the Z tilt are adjusted, the spread of the Z positions can be made generally less than in the case in which only the Z position is adjusted. Thus, in the case in which both the Z position and the Z tilt are adjusted, the imaging regions can be made wider than those in the case in which only the Z position is adjusted. From the standpoint of reducing the processing time, it is desirable that the number of imaging regions be reduced. Therefore, it is preferred that the largest imaging region be set in the reference table within a range in which the substances are confined within the depth of field. In the third embodiment, similarly to the second embodiment, all of the imaging regions have the same size.

Once the spread of the imaging regions has been determined in the above-described processing, the image pickup is performed in each imaging region in step ST304. The processing of steps ST304 to ST307 is identical to that of steps ST111 to ST114 of the first embodiment.

In the flow shown in FIG. 10, the Z positions are measured and the statistical amount of the Z positions is calculated for each slide (ST301, ST302), but this processing can be omitted. For example, when the slides of the substances of the same type and of the same lot are continuously processed, it is possible to perform the measurements and calculate the statistical amount only for the very first slide and use the same statistical amount for the following slide. The processing of steps ST301 and ST302 can thus be omitted and therefore the processing time can be reduced.

With the method of the third embodiment described hereinabove, the imaging regions can be determined and the combined image can be obtained in a manner even simpler than that of the first embodiment and second embodiment. Further, in a further simplified example of the processing, the spreads of the Z positions may be classified into two types. For example, the processing of determining the imaging regions is simplified by managing the slides separately in two groups, namely, the old slides in which the spread of the Z positions is large and the new slides in which the spread of the Z positions is small and the images can be picked up in broader imaging regions. More specifically, a table is used in which the spreads of the Z positions (or the sizes of the imaging regions) are set with respect to the old slides and new slides. The imaging apparatus determines whether the slide is old or new, narrows the imaging regions in the case of an old slide, and broadens the imaging regions in the case of new slides. As a result, the effect of the present invention can be obtained in a simpler manner. As follows from the explanation above, the “spread of the Z positions of the substances” used in the present invention is not necessarily a numerical value that directly represents the spread, such as the pp value or standard deviation of the Z positions of the substances within the imaging regions. For example, information that indirectly represents the spread of the Z positions of the substances, such as new or old slide, process for preparing the slides, and types of substances, can be also used.

### Fourth Embodiment

The fourth embodiment of the present invention is described below. In the fourth embodiment, an example is explained in which the present invention is applied to an imaging apparatus that uses an area sensor as an image sensor. In the entire configuration which is shown in FIG. 2B, one area sensor is disposed with respect to one imaging optical system 1. A flow diagram for explaining the imaging apparatus is substantially identical to that (FIG. 3) of the first embodiment, the difference being in that the type of the image sensor is changed from the line sensor 200 to the area sensor 300.

Specific operations of the controller unit 3 and the image processing unit 2 can be represented as a two-dimensional expansion of the processing flow explained in the first to third embodiments. Hence, detailed explanation is omitted here. In the fourth embodiment, the size of the imaging regions is also adaptively determined on the basis of the regional Z-positions spread and the spread of the Z positions that are explained in the first to third embodiments.

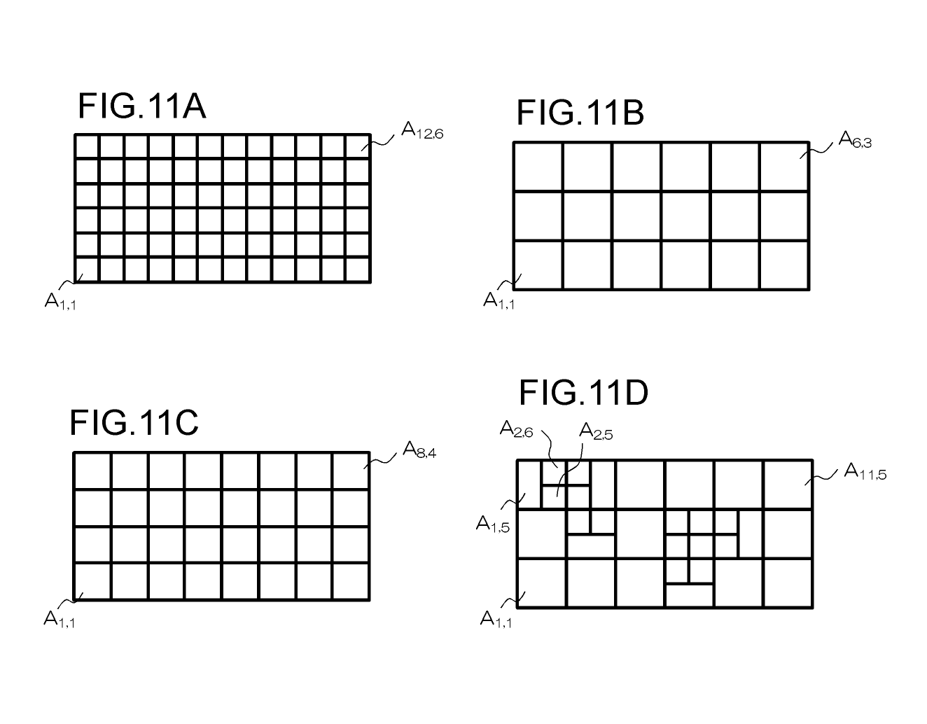

Examples of the imaging regions determined in the fourth embodiment are explained below with reference to FIGS. 11A, 11B, 11C, 11D. FIGS. 11A, 11B, 11C, 11D show schematically the imaging regions on the slide.

FIG. 11A shows schematically an example of the imaging regions obtained by the conventional method. As shown in FIG. 11A, the imaging regions in the conventional imaging apparatus are narrow. Therefore, the problem of the substances getting out of the depth of field is practically not encountered. In other words, the slide is prepared such that there are no substances out of the depth of field. FIGS. 11B to 11D illustrate examples of the imaging regions on the slides that are obtained by the method of the fourth embodiment of the present invention. FIGS. 11B and 11C show examples of the imaging regions determined by the statistical amount of the spread of the Z positions of the substances that is described in the second or third embodiment of the present invention. In this case, all of the imaging regions have the same surface area. FIG. 11D illustrates an example of the imaging region on the slide in which an imaging region is determined by the method described in the first embodiment of the present invention. In the portions with a large spread of the Z positions of the substances, the imaging regions are narrow, and in the portions with a small spread, the imaging regions are wide.

In the fourth embodiment of the present invention, an area sensor is used as the image sensor. Therefore, the imaging regions are determined two dimensionally. Accordingly, it is preferred that the imaging regions be formed by combining basic regions (smallest units of imaging regions) such that no gaps appear between the imaging regions. In the example shown in FIG. 11D, a region of a square shape, such as A_{2,5}, is the basic region, and the imaging region is formed by one basic region, two basic regions (A_{1,5} and the like), or four basic regions (A_{1,1} or the like). Where the imaging regions are thus formed by using one basic region or combining a plurality of basic regions, it is easy to determine the shape and size of the imaging regions such that no gaps appear between the imaging regions.

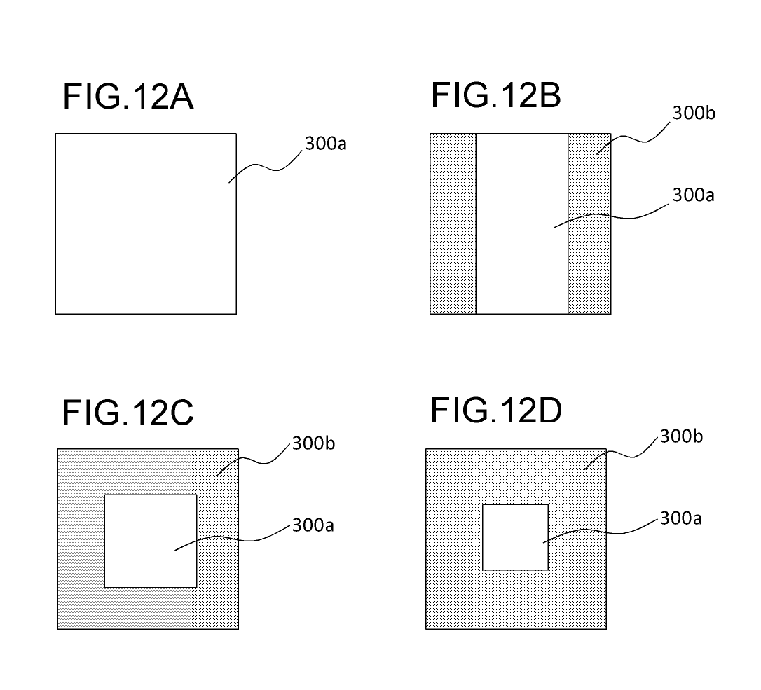

FIGS. 12A to 12D illustrate schematically the imaging regions of the area sensor. In the figures, the reference numeral 300a stands for an imaging region (range of pixels for which image data are acquired), and the reference numeral 300b stands for an image non-pickup region (range of pixels for which image data are not acquired). FIG. 12A shows the imaging region 300a of the area sensor 300 in the case in which the imaging region is not restricted (maximum imaging region). In this case, an image is received from all of the effective pixels of the line sensor 300. Thus, the imaging region is identical to the image pickup area. FIGS. 12B, 12C, and 12D show examples in which the imaging region of the area sensor 300 is narrowed. FIG. 12B shows an imaging region with a surface area ½ that of the image pickup area, FIG. 12C shows an imaging region with a surface area ¼ that of the image pickup area (the length of each side is reduced in half), and FIG. 12D shows an imaging region with a surface area 1/9 that of the image pickup area. Characteristics of the imaging optical system 1 are typically better in the central portion than in the peripheral portion. This is why when the imaging region is narrowed, it is better to use the pixels positioned in the central portion of the field of view of the imaging optical system 1, from among the effective pixels of the area sensor 300. In this case, the centers of the imaging optical system 1 and the area sensor 300 match and therefore the pixels of the central portion of the area sensor 300 are preferentially used, as shown in FIGS. 12B to 12D.

As mentioned hereinabove, the fourth embodiment of the present invention can be advantageously applied to an imaging apparatus of a digital camera type that uses a two-dimensional image sensor. In such a configuration, a focused high-quality image can be also acquired, in the same manner as in the above-descried embodiments, by enlarging the imaging regions when the spread of the Z positions of the substances is small and narrowing the imaging regions when the spread of the Z positions of the substances is large.

### Fifth Embodiment

The fifth embodiment of the present invention is explained below. The difference between the fifth embodiment and the first to fourth embodiments of the present invention is that a plurality of image sensors are mounted with respect to one imaging optical system 1.

(Configuration Example Using Line Sensors)

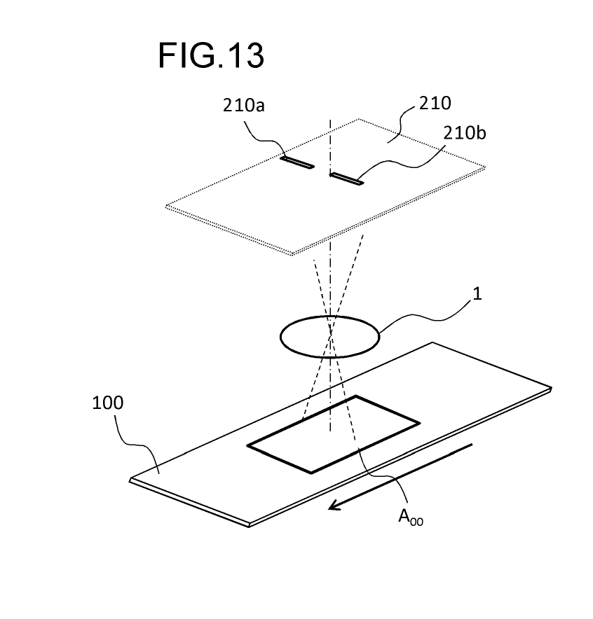

FIG. 13 shows schematically the configuration of the imaging apparatus using a plurality of line sensors, which represents the fifth embodiment of the present invention. In FIG. 13 the explanation of the reference numerals that have already been explained is omitted. In FIG. 13, the reference numeral 210 stands for a plane where the image sensors are disposed, 210a, 210b stand for line sensors, which are image sensors, and A₀₀ stands for an imaging target region on the slide side.

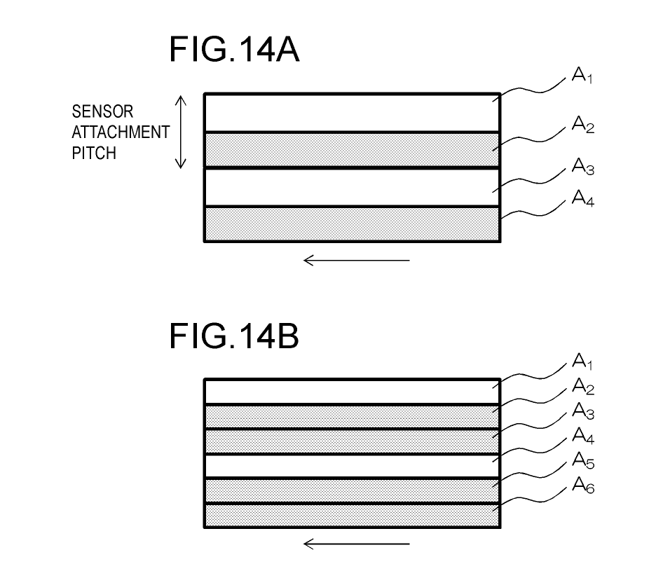

FIG. 14A shows schematically the imaging target region A₀₀ on the slide side that corresponds to the line sensor 210a and the line sensor 210b in the case where the imaging regions are not restricted. In FIG. 14A, A₁ is an imaging region corresponding to the line sensor 210a, and A₃ is an imaging region corresponding to the line sensor 210b. The two line sensors 210a, 210b are attached such that the width of the line sensors in the main scanning direction is an n-th part (n is an integer) of the sensor attachment pitch, so that the entire imaging target region A₀₀ could be scanned in a small number of scans. The relationship between the width of the line sensors in the main scanning direction (or the width of the image pickup area) and the sensor attachment pitch actually should be considered on the image plane on the line sensor side, but this relationship is described below by using a projection on the physical body plane on the slide side for convenience of explanation.

In the imaging regions A₁, A₃, the images are picked up simultaneously by one movement (scan) in the sub scanning direction. In the second scan in the sub scanning direction, the line sensor 210a picks up the image of the imaging region A₂ and the line sensor 210b picks up the image of the imaging region A₄. Thus, in the present embodiment, by mounting two line sensors on one imaging optical system, it is possible to reduce the number of scans by half with respect to that in the case where one line sensor is used, and the speed of forming the combined image is increased. In FIG. 13, the configuration using two line sensors is shown by way of example, but a large number of line sensors may be also mounted.

FIG. 14B shows an example of imaging regions on the slide side in the case where the imaging regions are restricted (narrowed). In FIG. 14B, A₁ is an imaging region on the slide side that corresponds to the line sensor 210a, and A₄ is an imaging region on the slide side that corresponds to the line sensor 210b. In this case, the width in the main scanning direction is restricted for both line sensors 210a, 210b by comparison with the configuration shown in FIG. 14A. In the first scan, the images of the imaging regions A₁ and A₄ are picked up. In the second scan, the images of the imaging regions A₂ and A₅ are picked up. In the third scan, the images of the imaging regions A₃ and A₆ are picked up. As a result, by implementing three times of scanning, image data on the entire imaging target regions A₀₀ can be acquired. In this case, as shown in FIG. 14B, the imaging regions of each sensor may be determined such that the width in the main scanning direction is an n-th part (n is an integer) of the sensor attachment pitch. In other words, the size of the imaging regions corresponding to each of a plurality of line sensors arranged in the main scanning direction (first direction) may be determined such that the width of each imaging region in the main scanning direction is an n-th part (n is an integer) of the length of the sensor attachment pitch projected on the imaging region. As a result, the entire imaging target region can be scanned efficiently.

In the fifth embodiment of the present invention, the size of the imaging regions is also adaptively determined on the basis of the information on the spread of the Z positions and the regional Z-positions spread by the method described in the first to fourth embodiments. As a result, the blurring of the image caused by the substances getting out of the depth of field can be inhibited.

For example, when the method of the first embodiment is used, in step ST107 shown in FIG. 4, the width of the main scanning for each line sensor is reduced in the order of ½, ⅓, ¼, . . . of the sensor attachment pitch. Further, the width of the main scanning (size of the imaging region) is determined such that the regional Z-positions spreads in the imaging regions of all of the line sensors are equal to or less than the depth of field. In this case, the focusing of the imaging optical system cannot be performed for each line sensor individually and therefore the calculation of the regional Z-positions spread and the determination of the depth of field are performed for all of the line sensors together.

When the method of the second embodiment is used, in step ST205 shown in FIG. 8, the width of the main scanning for each line sensor is reduced in the order of ½, ⅓, ¼, . . . of the sensor attachment pitch. Further, the width of the main scanning (size of the imaging region) is determined such that the regional Z-positions spreads in the imaging regions of all of the line sensors are equal to or less than the depth of field. With the method of the second embodiment, information on the spread of the Z positions, which are statistical data, is used. Therefore, it is not necessary to measure the slide or determine the depth of field of each line sensor.

When the method of the third embodiment is used, in step ST303 shown in FIG. 10, the width of the main scanning (size of the imaging region) is determined such that the width of the main scanning for each line sensor is an n-th part (n is an integer) of the sensor attachment pitch. Such a processing can be realized, for example, by using such settings in the reference table in which the statistical amount of the spread of the Z positions is associated with the size (width of the main scanning) of the imaging regions that the width of the main scanning is an n-th part (n is an integer) of the sensor attachment pitch.

(Configuration Example of Area Sensor)

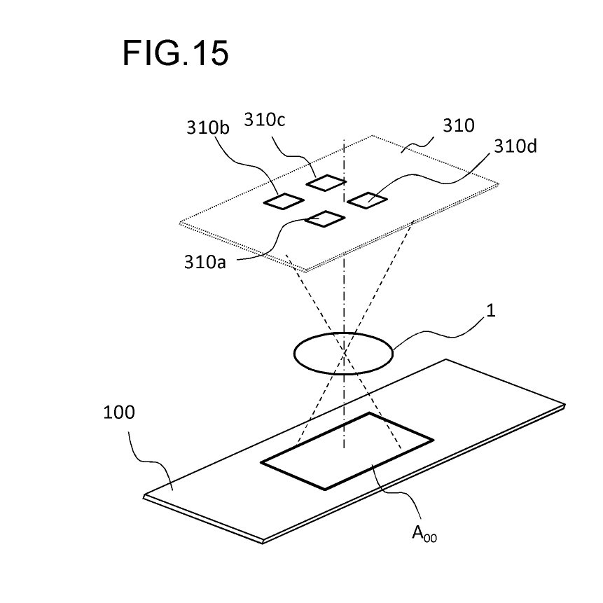

Another configuration example of the fifth embodiment of the present invention is described below. This embodiment differs from the above-described embodiments in that the image sensor is an area sensor. FIG. 15 shows schematically the configuration of an imaging apparatus using a plurality of area sensors. In FIG. 15, the explanation of the reference numerals that have already been explained is omitted. In FIG. 15, the reference numeral 310 stands for a plane where the image sensors are disposed, 310a, 310b, 310c, 310d stand for area sensors, which are image sensors, and A₀₀ stands for an imaging target region on the slide side. The combination of the area sensors 310a, 310b, 310c, 310d is called an imaging unit.

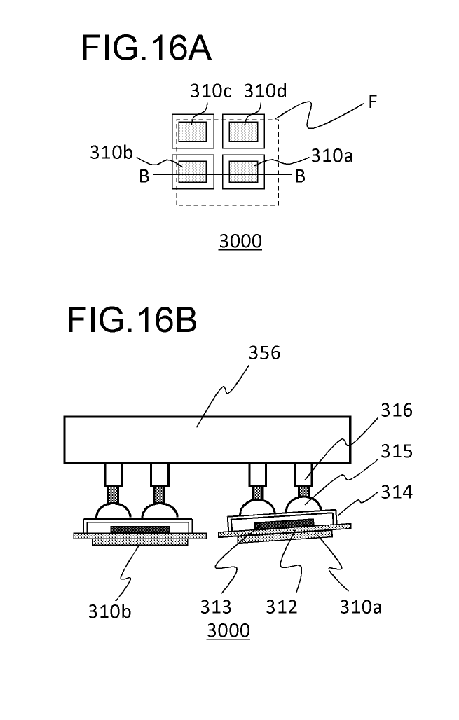

FIG. 16A is a top view of an imaging unit 3000 constituted by a plurality of area sensors 310a, 310b, 310c, 310d. As shown in FIG. 16A, the imaging unit 3000 includes an image sensor group constituted by a plurality of image sensors (area sensors) 310a, 310b, 310c, 310d arranged two-dimensionally within a field of view F of the imaging optical system 1, and the imaging unit is configured such that a plurality of images can be picked up at once. A CCD (Charge Coupled Device) or a CMOS (Complementary Metal Oxide Semiconductor) sensor can be used as the image sensor. The number of area sensors that are installed in the imaging unit 3000 can be determined, as appropriate, according to the surface area of the field of view of the imaging optical system 1. The arrangement of the area sensors can be also determined, as appropriate, according to the shape of the field of view of the imaging optical system 1 and the shape and configuration of the area sensors. In the present embodiment, CMOS sensors are arranged in a 2×2 configuration as an image sensor group in order to facilitate the explanation.

In a typical imaging unit 3000, since a substrate is present around the image pickup surfaces (effective pixel regions) of the area sensors 310a, 310b, 310c, 310d, the area sensors 310a, 310b, 310c, 310d cannot be arranged adjacently without gaps being present therebetween. Therefore, in the image obtained in one imaging cycle in the imaging unit 3000, portions corresponding to the gaps between the area sensors 310a, 310b, 310c, 310d are omitted. Accordingly, in order to fill the gaps between the area sensors 310a, 310b, 310c, 310d, a configuration is used in which the imaging operation is performed a plurality of times, while moving the stage holding the slide 100 and changing the mutual arrangement of the slide 100 and the image sensor group, thereby acquiring an image of the imaging target region A₀₀ without omissions. By performing this operation at a high rate, it is possible to pick up the image of a wide region, while reducing the time required for the image pickup. Since the imaging unit 3000 is also disposed on the stage, it is possible to move the stage holding the imaging unit 3000, instead of moving the stage holding the slide 100.

Further, the imaging unit 3000 has a drive mechanism including a plurality of drive units. Each of the plurality of drive units drives the corresponding image pickup face of the plurality of area sensors 310a, 310b, 310c, 310d. This drive is described below in greater detail with reference to FIG. 16B. FIG. 16B is a B-B sectional view of the configuration shown in FIG. 16A. As shown in FIG. 16B, the area sensors 310a, 310b, 310c, 310d are provided with a substrate 312, an electric circuit 313, a holding member 314, a connection member 315, and a drive member (cylinder) 316. Further, the drive member 316 is provided on a platen 356. The connection member 315 and the drive member 316 constitute a drive unit. Three sets of the connection member 315 and the drive member 316 are provided for each area sensor 310a, 310b, 310c, 310d (in FIG. 16B, only two front sets thereamong are shown). The connection member 315 is fixed to the holding member 314 and configured to be rotatable about the connection portion thereof with the drive member 316. Therefore, the drive unit is configured such that the positions of the image pickup faces of the area sensors 310a, 310b, 310c, 310d in the Z direction can be changed and tilt (tilt angle) of the image pickup faces can be also changed. The drive mechanism described herein can be also applied to the image sensors (including a line sensor) of other embodiments.

The stage where the slide 100 is held includes a holding unit that holds the slide 100, a XY stage that moves the holding unit in the XY direction, and a Z stage that moves the holding unit in the Z direction. In this case, the Z direction corresponds to the optical axis direction of the imaging optical system, and the XY directions correspond to the directions perpendicular to the optical axis. The XY stage and Z stage are provided with an opening transmitting the light that illuminates the slide 100.

The stage that holds the imaging unit 3000 is configured to be movable in the XYZ directions, and the position of the image sensor group can be adjusted. The stage holding the imaging unit 3000 is also configured to be rotatable about each of the XYZ axes, and the tilt and rotation of the image sensor group can be adjusted.

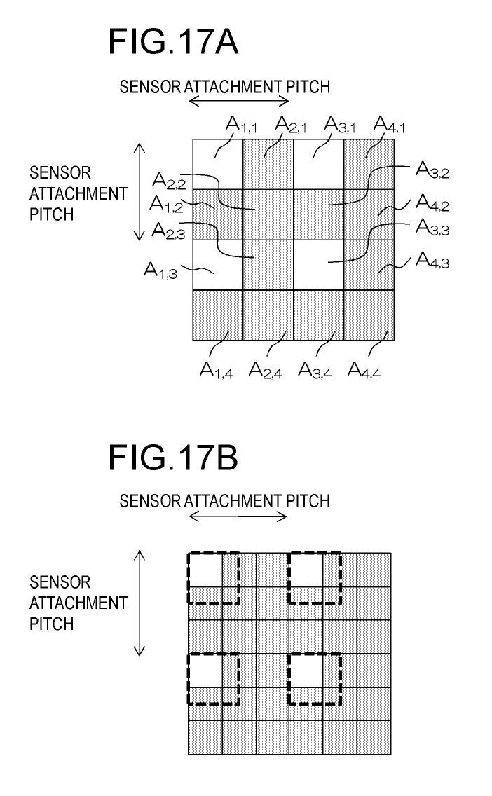

FIG. 17A shows in detail the imaging target region A₀₀ and the imaging regions (that is, image pickup area) on the slide side that correspond to the area sensor 310a, area sensor 310b, area sensor 310c, and area sensor 310d in the case where the imaging regions are not restricted. In FIG. 17A, A_{1,1} stands for an imaging target region corresponding to the area sensor 310a, A_{3,1} stands for an imaging target region corresponding to the area sensor 310b, A_{1,3} stands for an imaging target region corresponding to the area sensor 310c, and A_{3,3} stands for an imaging target region corresponding to the area sensor 310d.

The four area sensors are attached such that the length of the effective pixel region (in the X, Y directions) of the area sensor is an n-th part (in this example ½) of the sensor attachment pitch, so that the image of the entire imaging target region A₀₀ could be picked up in a small number of shots. The relationship between the effective pixel region (or imaging region) of the area sensor and the sensor attachment pitch actually should be considered on the image plane on the area sensor side, but this relationship is described below by using a projection on the physical body plane on the slide side for convenience of explanation.

The area sensor 310a picks up the image of the imaging region A_{1,1} in the first shot. At the same time, the area sensor 310b picks up the image of the imaging region A_{3,1}, the area sensor 310c picks up the image of the imaging region A_{1,3}, and the area sensor 310d picks up the image of the imaging region A_{3,3}. The stage (or the imaging optical system 1) is then moved to make a transition to the next stage. In the second shot, the area sensors 310a to 310d pick up the images of the imaging regions A_{1,2}, A_{3,2}, A_{1,4}, and A_{3,4}. In the third shot, the area sensors 310a to 310d pick up the images of the imaging regions A_{2,1}, A_{4,1}, A_{2,3}, and A_{4,3}. In the fourth shot, the images of the imaging regions A_{2,2}, A_{4,2}, A_{2,4}, and A_{4,4} are picked up. Thus, the image of the entire imaging target region can be picked up in four shots. In the present embodiment, by mounting four area sensors on one imaging optical system, it is possible to reduce by ¼ the number of shots and also reduce the processing time by comparison with those of the case where one area sensor is used. FIG. 15 illustrates a configuration example including four area sensors, but a larger number of area sensors may be also mounted.

FIG. 17B shows an example of imaging regions on the slide side in the case where the imaging regions are restricted (narrowed). Quadrangles shown by dot lines in FIG. 17B are obtained by projecting the image pickup areas of the four area sensors on the physical body plane on the slide side and correspond to imaging regions in the first shot illustrated by FIG. 17A. As shown in FIG. 17B, the width of the imaging region of each area sensor is set to ⅓ the sensor attachment pitch. In this case, the image of the entire imaging target region can be picked up in nine shots. Thus, the imaging region of each area sensor may be determined such that the width (length of the vertical and transverse sides) of the imaging region becomes an n-th part (n is an integer) of the sensor attachment pitch. In other words, the size of the imaging region corresponding to each of the two image sensors arranged side by side in the vertical direction (or transverse direction) may be determined such that the width of each imaging region in the vertical direction (or transverse direction) becomes an n-th part (n is an integer) of the length of the sensor attachment pitch projected on the imaging region. As a result, the image of the entire imaging target region can be effectively taken in.

In the configuration using area sensors, the size of the imaging regions is also adaptively determined on the basis of the information on the spread of the Z positions and the regional Z-positions spread by the method described in the first to fourth embodiments. As a result, the blurring of the image caused by the substances getting out of the depth of field can be suppressed.

As described hereinabove, in the fifth embodiment of the present embodiment, the image pickup processing in a wide range can be performed at a high speed by simultaneously picking up images with a plurality of image sensors. Further, in the present embodiment, unnecessary image data can be prevented from being taken in, the efficiency of image pickup processing and image combination processing can be increased, and the processing time can be reduced by determining the width of the imaging regions on the basis of the sensor attachment pitch.

### Sixth Embodiment

As described in the fifth embodiment, in an imaging apparatus of a configuration in which a plurality of image sensors are mounted on one imaging optical system, the blurring of the image can be inhibited by adaptively changing the size of the imaging regions according to the information on the spread of the Z positions or the regional Z-positions spread. However, depending on the state of the substances, the blurring of the image sometimes cannot be sufficiently prevented by only adjusting the size of the imaging regions as described in the fifth embodiment. In such a case, the method of the sixth embodiment can be effective.

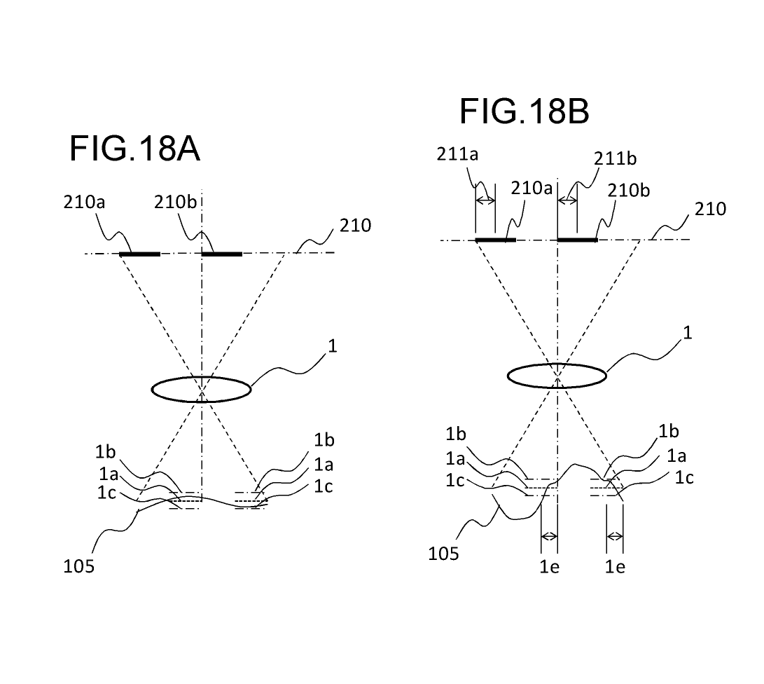

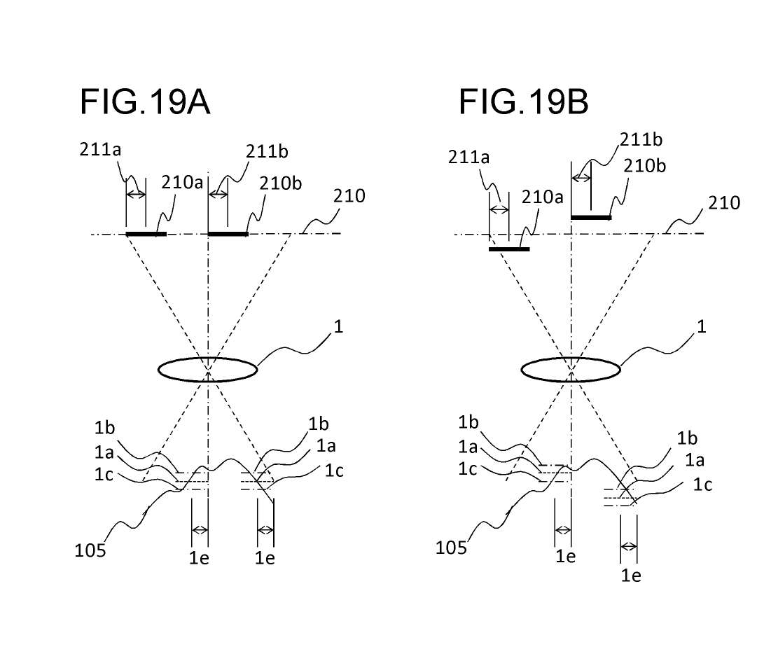

The sixth embodiment of the present embodiment is explained below with reference to FIGS. 18A, 18B, 19A, and 19B. FIGS. 18A, 18B, 19A, and 19B illustrate an example of an imaging apparatus in which a plurality (two) of line sensors are provided in one optical system. The explanation of the reference numerals that have been mentioned hereinabove is omitted. In the figures, the reference numerals 211a, 211b stand for imaging regions of the line sensors 210a, 210b that are restricted according to the spread of the Z positions of the substances. The reference numeral 1e stands for an imaging region on the slide.

FIG. 18A shows an example relating to the case in which an image is picked up for a slide with a small spread of the Z positions 105 of the substances. As shown in FIG. 18A, in a slide with a small spread of the Z positions 105 of the substances, the Z positions 105 of the substances are not out of the depth of field even when the imaging regions are widened. Thus, the image of the substances is not blurred. FIG. 18B shows an example relating to the case in which an image is picked up for a slide with a large spread of the Z positions 105 of the substances. In the case of the substances shown in FIG. 18B, the Z positions 105 of the substances can be fitted into the depth of field by narrowing the imaging regions.

FIG. 19A also shows an example relating to the case in which an image is picked up for a slide with a large spread of the Z positions 105 of the substances. Although the spread of the Z positions of the substances is almost the same in FIGS. 19A and 18B, in the case of the substances shown in FIG. 19A, the substances get out of the depth of field even when the imaging regions are narrowed. This is because the focal positions of the two line sensors are at the same height (Z position), since the line sensors 210a, 210b are disposed in the same plane 210. When the images are picked up at the positions of the substances shown in FIG. 19A, where the focus is adjusted on the substances in the imaging region of one line sensor, the substances get out of the depth of field in the imaging region of the other line sensor.

In order to resolve this problem, in the sixth embodiment of the present invention, the above-described drive unit is provided for each of the line sensors 210a, 210b, which are the image sensors, as shown in FIG. 19B, and the focal position is adjusted individually for each image sensor. A drive unit similar to that shown in FIG. 16B can be used in this case. As shown in FIG. 19B, the Z positions 105 of the substances can be confined within the depth of field in each imaging region by moving the line sensors 210a, 210b individually in the Z directions by the drive units. The drive units not only may move the image sensors in the Z direction, but also may perform tilt (inclination) control of the image sensors. Where both the Z position and the tilt of the image sensors are adjusted according to the spread of the Z positions of the substances, the one-cycle imaging region can be further expanded. The drive amount of the drive unit can be determined, for example, by performing calculations that are similar to those performed when determining the focal position in the first embodiment for each of the line sensors 210a, 210b.

The configuration with two image sensors is particularly advantageous in an embodiment in which the aforementioned adjustment mechanism is mounted on one image sensor. Thus, where focal positions are matched by moving the stage of the slide with respect to the immovable image sensor and at least either of the Z position and the tilt of the other image sensor is adjusted in this state of the stage, focal positions of both image sensors are adjusted.

In the explanation above, an imaging apparatus using line sensors is described by way of example, but the method described in the sixth embodiment (method for adjusting the focal position for each image sensor) may be also applied to the imaging apparatus using area sensors.

As explained hereinabove, in the sixth embodiment of the present invention, a drive unit is provided for adjusting the Z position or tilt of the focal position for each image sensor by moving or tilting a plurality of image sensors (line sensors or area sensors) individually. As a result, the adequate focal position (depth of field) matching the Z positions of the substances can be set for each of a plurality of imaging regions that are picked up simultaneously by a plurality of image sensors, thereby making it possible to acquire an image of even higher quality.

### Seventh Embodiment

The seventh embodiment of the present invention will be described below. In the sixth embodiment, in an imaging apparatus in which a plurality of image sensors are mounted on one optical system, drive units are provided at a one-to-one ratio to the image sensors and each image sensor is moved in the Z direction so that the Z positions of the substances within the imaging regions and the focal position match. The merit of such a configuration is that focused image data are simultaneously acquired from a plurality of image sensors and therefore a high-quality combined image can be generated at a high rate. However, in the configuration of the sixth embodiment, a plurality of drive units is required and the image sensors are difficult to mount. Therefore, it is highly probable that the cost will rise. Accordingly, in the configuration of the seventh embodiment, the problem illustrated by FIG. 19A is resolved, without providing the drive units, in other words, without moving the Z positions of the image sensors.

The essence of the seventh embodiment is that in a slide with a large spread of the Z positions, the substances are prevented from getting out of the depth of field (blurred image pickup is prevented) by reducing the number of the image sensors used (processed). For example, in the case of an imaging apparatus having two image sensors, a simple processing involves performing switching such that where the spread of the Z positions is larger than a predetermined threshold, the number of image sensors is reduced by one, whereas in other cases two image sensors are used. Likewise, in the case where the number of the image sensors is equal to or greater than three, the control may be performed to reduce the number of the image sensors as the spread of the Z positions increases. Alternatively, as in the case of the first embodiment, when the spread of Z positions at each position on the slide is known, the image sensor to be used can be determined by estimating for each image sensor whether or not the spread of the Z positions of the substances is equal to or less than the depth of field. The functions of an imaging control unit for determining and controlling those image pickup conditions are performed by the image processing unit 2 and the controller unit 3 shown in FIG. 3.

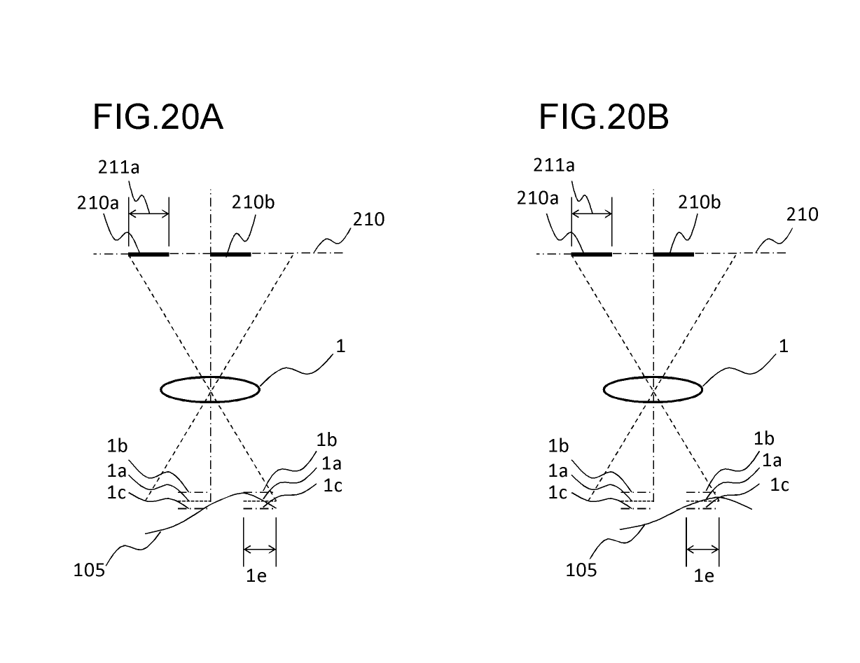

An example of the control of the image sensors of the seventh embodiment of the present invention is explained below with reference to FIGS. 20A and 20B. The explanation of the reference symbols mentioned hereinabove is herein omitted. FIGS. 20A and 20B illustrate an imaging apparatus in which two line sensors are mounted on one imaging optical system. FIG. 20A illustrates the first scan and FIG. 20B illustrates the second scan. As shown in the figures, the Z positions 105 of the substances are fitted in the depth of field in both the first and the second scans by using only the line sensor 210a. Meanwhile, in the imaging regions of the line sensor 210b, the Z positions 105 of the substances cannot be confined within the depth of field and therefore the processing of image data of the line sensor 210b is prohibited.

Thus, in the seventh embodiment of the present invention, the control is performed to reduce the number of the image sensors to be used when the spread of the Z positions of the substance is large. Therefore, when the spread of the Z positions of the substances is large, the increase in the number of scans results in the increase in time required to generate a combined image. However, since the substances can be prevented from getting out of the depth of field, a focused high-quality combined image can be generated. Since the processing time and image quality are in a tradeoff relationship, the user may select which is more important. For example, the condition (threshold and the like) for reducing the number of image sensors may be adjusted to be light when the processing time is a priority and severe when the image quality is a priority.

The control of the present embodiment may be combined with those of the fifth and sixth embodiments. For example, where the spread of the Z positions 105 of the substances is larger than that shown in FIG. 20A and FIG. 20B, it is possible not only to reduce the number of the image sensors to be used (driven), but also to narrow the imaging regions. Alternatively, even when the imaging regions are narrowed and the Z movement of image sensors is performed in the sixth embodiment, the number of the image sensors to be used may be reduced when the spread of the Z positions of the substances remain unconfined within the depth of field. Where the positions of the image sensors, size of the imaging regions, and number of the image pickup to be processed are controlled, as appropriate, according to the spread of the Z positions of the substances, the substances can be more reliably prevented from getting out of the depth of field.

The spread of the Z positions in the seventh embodiment is estimated in order to determine how many (or which) of a plurality of image sensors that have been discretely disposed are to be used. Therefore, the shift amount of the Z positions of the substances at separate positions on the slide, that is, the low-frequency component of the spatial frequency in the spread (spatial distribution) of the Z positions, can be estimated.

In the seventh embodiment of the present invention, the below-described method is effective for simplifying the processing of determining whether to use the image sensors and restricting the imaging regions. Thus, slides of two types, namely, an old slide that has been used in the conventional imaging apparatus with a narrow field of view and a new slide corresponding to image pickup in a wide field of view, are managed. In the old slide, the spread of the Z positions of the substances can be large, whereas the new slide is prepared such that the flatness of the Z position of the substances is high to enable image pickup within a wide field of view. The imaging apparatus determines whether the slide for which image pickup is to be performed is an old slide or a new slide. In the case of an old slide, the number of the image sensors is restricted to one, the imaging regions are narrowed to the level of the conventional imaging apparatuses, and the combined image is generated in a number of imaging cycles same as in the conventional imaging apparatus, that is, at a rate on par with the conventional rate. In the case of a new slide, the combined image is rapidly generated by using a plurality of image sensors. With such a control, the processing algorithm is simplified and the structure is also simplified since the drive units of the image sensors are not required. Therefore, an imaging apparatus can be realized at a low cost. Further, since it is not necessary to measure and estimate the spread of the Z positions or calculate the imaging regions, high-speed generation of the combined image can be realized.

As described hereinabove, in the seventh embodiment of the present invention, in an imaging apparatus in which a plurality of image sensors are provided for one optical system, the number of the image sensors that are used when the spread of the Z positions is large is reduced, thereby making it possible to acquire a high-quality image in the same manner as in the above-described embodiments. Further, with such a configuration, drive units for adjusting the Z positions of the image sensors are not required and therefore the configuration is simplified and reduced in cost.

### Eighth Embodiment

The eighth embodiment of the present invention is described below. The essence of the eighth embodiment of the present invention is that a plurality of image sensors that differ in the image pickup area are provided and the image sensor to be used is selected according to the size of the spread of the Z positions, thereby obtaining the effect equivalent to that obtained by changing the size of the imaging regions.

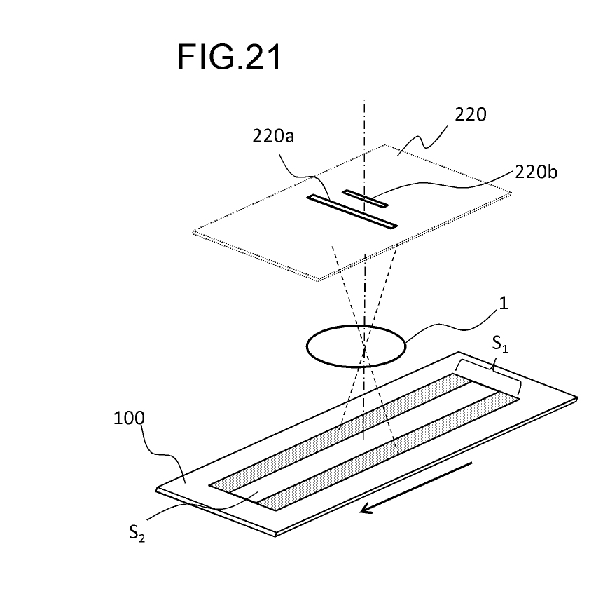

FIG. 21 illustrates schematically the configuration of the imaging apparatus of the eighth embodiment of the present invention. In this example, two line sensors are provided with respect to one imaging optical system 1. In FIG. 21, the reference numeral 220 stands for a plane on which a plurality of line sensors are mounted, 220a stands for a line sensor with a wide image pickup area, and 220b stand s for a line sensor with a narrow image pickup area. Further, S1 (the entire zone including a wide portion and gray portions on both sides) is an imaging region on the slide 100 corresponding to the line sensor 220a with a wide image pickup area, and S2 (the white portion) is an imaging region corresponding to the line sensor 220b with a narrow image pickup area.

In this imaging apparatus, when the spread of the Z positions is large, the image is picked up using the line sensor 220b with a narrow image pickup area in order to narrow the imaging region. Meanwhile, when the spread of the Z positions is small, the image is picked up by using the line sensor 220a with a wide image pickup area in order to widen the imaging region. Other types of processing (estimation of the spared in the Z positions, formation of the combined image, and the like) are same as in the other embodiments and therefore the explanation thereof is omitted. In FIG. 21, the line sensors 220a and 220b are at different positions in the sub scanning direction, but this difference in positions may be corrected by shifting the scanning start position (image read timing). Alternatively, the image data may be held in a memory and the position in the sub scanning direction may be corrected by changing the position of reading from the memory. The functions of an imaging control unit for determining and controlling those image pickup conditions (the image sensor to be used, focal position, scanning start position, and the like) are performed by the image processing unit 2 and the controller unit 3 shown in FIG. 3 described hereinabove.

FIG. 21 illustrates an example in which line sensors are used as the image sensors, but a similar control can be also implement by using a plurality of area sensors that differ in the size of the image pickup area. In the case of area sensors, two sensors may be mounted on a plane where the sensors are mounted, but since a wide field of view is required for the imaging optical system and the cost rises, it is preferred that the optical path be split by a half mirror and that a plurality of area sensors be mounted on separate planes.

According to the eighth embodiment of the present embodiment, by preparing a plurality of image sensors that differ in the image pickup area and switching the image sensors to be used according to the spread of the Z positions of the substances, it is possible to acquire a high-quality image in the same manner as in the abovementioned embodiments by using a simple configuration.

### Other Embodiments

### Method for restricting imaging region

In the above-described embodiments, an example is shown in which the image processing unit 2 restricts (narrows) the imaging regions. For example, in the first embodiment, all of the image data outputted from the line sensor 200 are inputted to the image processing unit 2, and the image processing unit 2 cuts down the image data of the necessary regions by image processing. This method features the following merits: it is not necessary to change the operation timing of the line sensor 200, no special additional circuit should be provided to the line sensor 200, and the imaging regions can be easily restricted to any size. It goes without saying that when the image processing unit 2 restricts (narrows) the imaging regions, this approach can be effectively applied also to area sensors.

In another method for restricting the imaging regions, the operation timing of the line sensor 200 is changed and only the image data of the necessary regions are outputted from the line sensor 200. This method is typically called a cropping method. With this method, the unnecessary image data (that are not used for combined image formation processing) are not outputted. Therefore, the transfer time required for outputting the image data is reduced. The resultant merit is that data processing can be performed at a high rate. It goes without saying that a method by which the necessary image data are accurately cut down by the image processing unit 2 after the imaging regions have been roughly restricted by cropping can be also advantageously used. The method for restricting the imaging regions by cropping can be also advantageously applied to area sensors.

(Control of Whether Merge Processing is Required)

In the above-described embodiments, the images of the slide are picked up in a plurality of shots, and the obtained plurality of images is merged to generate the entire combined image. Such segmented image pickup and merge processing are not required when the imaging region (image pickup area) of the image sensor is larger than the imaging target region on the slide. An example in which the present invention is applied to such imaging apparatus is explained below.

Such imaging apparatus has a mode of acquiring an image of the entire object in one imaging operation (entire imaging mode) and a mode of generating an image of the entire object by merging images of a plurality of imaging regions obtained by a plurality of imaging operations (segmented imaging mode). Which mode to execute is determined by the controller unit 3 and the image processing unit 2 functioning as an imaging control unit. More specifically, when the spread of the Z positions is small or when the regional Z-positions spread of the imaging target region is equal to or less than the depth of field, the entire imaging mode is used, the segmented imaging and merge processing are determined to be unnecessary, and the image of the entire imaging target region is imaged in one shot. Meanwhile, when the spread of the Z positions is large or when the regional Z-positions spread of the imaging target region exceeds the depth of field, the segmented imaging mode is used, the imaging regions of the image sensors are restricted (narrowed), the segmented imaging is performed, and a focused entire image (combined image) is generated by merging (combining) the images obtained in the segmented imaging. The evaluation of the spread of the Z positions, the restriction of the imaging regions, and the merging of the images may be performed in the same manner as in the above-described embodiments. By performing such control, when the spread of the Z positions of the substances is small, the processing speed can be increased since the segmented imaging and merge processing are omitted, and when the spread of the Z positions of the substances is large, the blurred image is prevented from being picked up and a focused high-quality image can be obtained.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-215299, filed on Sep. 29, 2011, and Japanese Patent Application No. 2012-152645, filed on Jul. 6, 2012, which are hereby incorporated by reference herein in their entirety.

1. An imaging apparatus that images an object and generates a digital image, comprising:
an image sensor;
an imaging optical system that enlarges and forms an image of the object on the image sensor; and
an imaging control unit for controlling a size of an imaging region which is a range in which image data are acquired by the image sensor in one imaging cycle and controlling a focal position when the imaging region is imaged, wherein
the object includes substances with different Z positions, which are positions in the optical axis direction of the imaging optical system; and
the imaging control unit determines the size of the imaging region according to a spread of the Z positions of the substances so that the imaging region in the case where the spread of the Z positions of the substances is relatively large is narrower than the imaging region in the case where the spread of the Z positions of the substances is relatively small.

2. The imaging apparatus according to claim 1, wherein
the imaging control unit determines the size of the imaging region and focal position such that the Z positions of the substances are within a depth of field.

3. The imaging apparatus according to claim 1, further comprising:
an image processing unit for merging the images of a plurality of imaging regions obtained in a plurality of imaging operations and generating a combined image of the object in the entirety, wherein
the imaging control unit determines the size of each of the plurality of imaging regions so that no gap appears between the plurality of images obtained from the plurality of imaging regions.

4. The imaging apparatus according to claim 1, wherein
the imaging control unit
(A) calculates the spread of the Z positions of the substances from the result obtained by actually measuring the Z positions of the substances included in the object to be imaged;
(B) acquires data conforming to the object to be imaged from a database in which data representing statistical values of the spread of the Z positions of the substances have been stored in advance; or
(C) acquires data conforming to the object to be imaged from a database, in which data representing statistical values of the spread of the Z positions of the substances have been stored in advance, on the basis of attribution information of the object which is read from information tag storing the attribution information of the object.

5. The imaging apparatus according to claim 1, wherein
the spread of the Z positions of the substances is a spread of a difference between the Z position of each substance or an approximate curved surface determined from the Z positions of the substances and the focal position; and
the imaging control unit determines the position of the focal position in the optical axis direction or the position and tilt of the focal position in the optical axis direction such that the spread of the Z positions of the substances becomes smaller.

6. The imaging apparatus according to claim 1, wherein
the image sensor is a one-dimensional image sensor;
the imaging region is a rectangular region determined by the width of a main scanning and the width of a sub scanning of the one-dimensional image sensor; and
the imaging control unit controls the width of the main scanning, the width of the sub scanning, or both the width of the main scanning and the width of the sub scanning of the one-dimensional image sensor and the focal position, for each sub scanning, so that the Z positions of the substances within the imaging region are confined within the depth of field.

7. The imaging apparatus according to claim 1, wherein
the image sensor is a two-dimensional image sensor;
the imaging region is a region determined by a range of pixels for which image data are acquired from among effective pixels of the two-dimensional image sensor; and
the imaging control unit controls the range of pixels for which image data are acquired and the focal position, for each imaging operation, so that the Z positions of the substances within the imaging region are confined within the depth of field.

8. The imaging apparatus according to claim 2, wherein
the imaging control unit determines whether or not the Z positions of the substances within the imaging region are confined within the depth of field by calculating a statistical amount of the spread of the Z positions of the substances within the imaging region and estimating whether or not the statistical amount is equal to or less than the depth of field.

9. The imaging apparatus according to claim 8, wherein
the statistical amount is:
a difference between a maximum value and a minimum value of the Z positions of the substances within the imaging region;
a value obtained by multiplying a standard deviation of the Z positions of the substances within the imaging region by a predetermined coefficient; or
a value obtained by multiplying a value representing the spread of the Z positions of the substances per unit region by a surface area of the imaging region.

10. The imaging apparatus according to claim 1, wherein
one image sensor is provided to one imaging optical system, and
the imaging apparatus being further provided with a drive unit for adjusting the position or tilt of the focal position in the optical axis direction by moving or tilting at least either the object or the image sensor.

11. The imaging apparatus according to claim 1, wherein
one image sensor is provided to one imaging optical system, and
when only partial pixels of the image sensor are used to narrow the imaging region, the imaging control unit uses pixels positioned in a central portion of a field of view of the imaging optical system, from among the pixels of the image sensor.

12. The imaging apparatus according to claim 1, wherein
the imaging control unit switches modes according to the spread of the Z positions of the substances so that a mode of acquiring an image of the entire object in one imaging operation is executed when the spread of the Z positions of the substances is relatively small, and a mode of generating an image of the entire object by merging the images of a plurality of imaging regions obtained in a plurality of imaging operations is executed when the spread of the Z positions of the substances is relatively large.

13. The imaging apparatus according to claim 1, wherein
a plurality of image sensors are provided to one imaging optical system,
the imaging apparatus being further provided with a drive unit for adjusting the position and/or tilt of the focal position in the optical axis direction by moving and/or tilting at least one image sensor.

14. The imaging apparatus according to claim 13, wherein the imaging control unit controls the imaging region corresponding to each of a plurality of image sensors arranged in a row in a first direction with a predetermined pitch so that a width of each imaging region in the first direction is an n-th (n is an integer) part of a length of the predetermined pitch projected on the imaging region.

15. The imaging apparatus according to claim 13, wherein the imaging control unit changes the number of image sensors to be used according to the spread of the Z positions of the substances so that the number of the image sensors to be used in the case where the spread of the Z positions of the substances is relatively large is less than the number of the image sensors to be used in the case where the spread of the Z positions of the substances is relatively small.

16.-17. (canceled)

18. A method for controlling an imaging apparatus having an image sensor and an imaging optical system that enlarges and forms an image of an object on the image sensor,
the method comprising:
a determination step of determining a size of an imaging region which is a range in which image data are acquired by the image sensor in one imaging cycle and a focal position when the imaging region is imaged; and
an imaging step of imaging the object with the size of the imaging region and at the focal position determined in the determination step and generating a digital image, wherein
the object includes substances with different Z positions which are positions in an optical axis direction of the imaging optical system; and
in the determination step, the size of the imaging region is determined according to a spread of the Z positions of the substances so that the imaging region in the case where the spread of the Z positions of the substances is relatively large is narrower than the imaging region in the case where the spread of the Z positions of the substances is relatively small.

19.-20. (canceled)
